(19) United States
(12) Patent Application Publication
(10) Pub. No.: US 2025/0314374 A1
(43) Pub. Date: Oct. 9, 2025

(54) CORROSION-RESISTANT DECORATIVE LIGHTING

(71) Applicant: Willis Electric Co., Ltd., Taipei (TW)

(72) Inventor: Johnny CHEN, Taipei (TW)

(21) Appl. No.: 19/169,680

(22) Filed: Apr. 3, 2025

Related U.S. Application Data
(60) Provisional application No. 63/574,791, filed on Apr. 4, 2024.

(51) Int. Cl. F21V 31/00; F21K 9/238; F21S 4/10; F21Y 115/10

(52) U.S. Cl. CPC F21V 31/005; F21K 9/238; F21S 4/10; F21Y 2115/10

(57) ABSTRACT

A corrosion-resistant light-emitting diode lamp assembly, including: a lamp socket defining a cavity with first and second openings and an inner surface; an LED lamp including an LED and a lens projecting through the first opening such that a portion of the lens is inside the cavity and another portion is outside of the cavity, wherein the lens and the lamp socket form a gap therebetween, a first wire including a first conductor and a first insulator, the first conductor electrically connected to the LED lamp; a second wire including a second conductor and a second insulator, the second conductor electrically connected to the LED lamp; a separator portion in the second opening of the lamp socket and positioned between the insulators; and sealing material filling a portion of the cavity and contacting the conductors, the inner surface of the lamp socket, and the outer side surface of the lens.

### CROSS-REFERENCE TO RELATED APPLICATIONS

This application claims the benefit of U.S. Provisional Patent Application No. 63/574,791, filed Apr. 4, 2024, U.S. Provisional Patent Application No. 63/695,251, filed Sep. 16, 2024, and U.S. Provisional Patent Application No. 63/724,583, filed Nov. 25, 2024, which are incorporated herein in their entireties.

### FIELD OF THE DISCLOSURE

The present disclosure is generally directed to seasonal decorative lighting. More specifically the present disclosure is directed to water-resistant, corrosion-resistant lamps and light strings for seasonal decorative lighting.

### BACKGROUND

Decorative lighting, such as seasonal holiday lighting, generally includes decorative light strings, lighted trees, lighted decorative sculptures and other such lights and lighted objects. Such decorative lighting often comprises one or more strings of lights constructed of multiple wires, lamp assemblies and an electrical connector or power plug. Lamp assemblies typically include a light or lamp inserted into a lamp base, which is inserted into a lamp socket.

### SUMMARY

One embodiment of the present disclosure is a corrosion-resistant light-emitting diode (LED) lamp assembly, that comprises: a lamp socket defining a lamp-receiving cavity with a first opening and a second opening and including an inner surface; an LED lamp comprising at least one LED and a lens, the lens projecting through the first opening such that a portion of the lens is inside the lamp-receiving cavity and another portion of the lens is outside of the lamp-receiving cavity, wherein the lens and the lamp socket form a filling gap therebetween; a first wire including a first conductive portion and a first insulated portion, the first conductive portion electrically connected to the LED lamp; a second wire including a second conductive portion and a second insulated portion, the second conductive portion electrically connected to the LED lamp; a separator portion in the second opening of the lamp socket and positioned between the first insulated portion and the second insulator portion; and sealing material filling a portion of the lamp-receiving cavity and contacting the first conductive portion of the first wire, the second conductive portion of the second wire, the inner surface of the lamp socket, and the outer side surface of the lens.

Another embodiment is a corrosion-resistant light-emitting diode (LED) lamp assembly, that comprises: a lamp socket defining a lamp-receiving cavity with a first opening and a second opening and including an inner surface; an LED lamp projecting through the first opening, the LED including: a first-polarity lead frame; a second-polarity lead frame; an LED electrically connected to the first-polarity lead frame and the second-polarity lead frame; and a lens covering the LED, an upper portion of the first-polarity lead frame and an upper portion of the second-polarity lead frame, the lens including an outer side surface; a first wire including a first conductive portion and a first insulated portion, the first conductive portion electrically connected to the first-polarity lead frame; a second wire including a second conductive portion and a second insulated portion, the second conductive portion electrically connected to the second-polarity lead frame; a separator portion including a lower portion and an upper portion, the lower portion positioned in the second opening of the lamp socket and positioned between the first insulated portion and the second insulator portion, and the upper portion positioned between the first conductive portion of the first wire and the second conductive portion of the second wire; and sealing material filling a majority of the lamp-receiving cavity and contacting the first-polarity lead frame, the second-polarity lead frame, the first conductive portion and the second conductive portion, the inner surface of the lamp socket, and the outer side surface of the LED lens.

Yet another embodiment is a light-emitting diode (LED) bulb assembly, that comprises: a lamp socket defining a lamp-receiving cavity with a first opening and a second opening and including an inner surface; an LED lamp the LED lamp including: a first-polarity lead frame, a second-polarity lead frame, an LED electrically connected to the first-polarity lead frame and the second-polarity lead frame, and a lens covering the LED, an upper portion of the first-polarity lead frame and an upper portion of the second-polarity lead frame, the lens including an outer side surface, the outer side surface of the lens and the lamp socket forming a filling gap. The LED bulb assembly also comprises: a first wire including a first conductive portion and a first insulated portion, the first conductive portion electrically connected to the first-polarity lead frame; a second wire including a second conductive portion and a second insulated portion, the second conductive portion electrically connected to the second-polarity lead frame; a separator portion having a lower portion and an upper portion, the lower portion positioned in the second opening of the lamp socket between the first insulated portion of the first wire and the second insulator portion of the second wire, and the upper portion positioned between the first conductive portion and the second conductive portion; ultraviolet-curable sealing material filling a portion of the lamp-receiving cavity and contacting the first-polarity lead frame, the second-polarity lead frame, the first conductive portion and the second conductive portion, and the outer side surface of the LED lens; and a lamp cover having a base portion inserted into an upper portion of the lamp-receiving cavity devoid of the ultraviolet-curable sealing material.

### BRIEF DESCRIPTION OF THE FIGURES

The invention can be understood in consideration of the following detailed description of various embodiments of the invention in connection with the accompanying drawings, in which:

FIG. 1 is a perspective view of a moisture-resistant, corrosion-resistant LED lamp assembly, according to an embodiment of the present disclosure;

FIG. 2 depicts an LED lamp, conductor-lead-frame connectors and wires, of the corrosion-resistant LED lamp assembly of FIG. 1;

FIG. 3 is a perspective view of an LED lamp, according to an embodiment of the present disclosure;

FIG. 4 is a front view of the LED lamp of FIG. 3;

FIG. 5 is a top, schematic view of the LED lamp of FIG. 4, without a lamp lens, according to an embodiment of the present disclosure;

FIG. 6 is an electrical schematic diagram of an LED lamp, according to an embodiment of the present disclosure;

FIGS. 7A and 7B are electrical schematic diagrams of an LED lamp, according to an embodiment of the present disclosure;

FIGS. 8-11 depict various views of a conductor-lead-frame connector conductor-lead-frame connectors, according to an embodiment of the present disclosure;

FIG. 12 is a perspective view of a corrosion-resistant LED subassembly and a wire separator device, according to an embodiment of the present disclosure;

FIG. 13 is a front view of the corrosion-resistant LED subassembly and a wire separator device of FIG. 12, with the separator device depicted in cross section;

FIG. 14 is a front view of the corrosion-resistant LED subassembly and separator device in cross section of FIG. 13, assembled together, according to an embodiment of the present disclosure;

FIG. 15 is a perspective view of a separator device, according to an embodiment of the present disclosure;

FIG. 16 is a front view of a separator device, according to an embodiment of the present disclosure;

FIG. 17 is a top view of a separator device, according to an embodiment of the present disclosure;

FIG. 18 is a side, sectional view of a separator device, according to an embodiment of the present disclosure;

FIG. 19 is a bottom view of a separator device, according to an embodiment of the present disclosure;

FIG. 20 is a perspective view of lamp socket and corrosion-resistant LED lamp subassembly, according to an embodiment of the present disclosure;

FIG. 21 is a cross-sectional view of the lamp socket and corrosion-resistant LED lamp subassembly of FIG. 20;

FIG. 22 is a perspective view of the lamp socket and corrosion-resistant LED lamp subassembly of FIG. 20, assembled;

FIG. 23 is a cross-sectional view of the assembled lamp socket and corrosion-resistant LED lamp subassembly of FIG. 21;

FIG. 24 is a perspective view of a lamp socket, according to an embodiment of the present disclosure;

FIG. 25 is a front view of a lamp socket, according to an embodiment of the present disclosure;

FIG. 26 is a cross-sectional view of a lamp socket, according to an embodiment of the present disclosure;

FIG. 27 is a top view of a lamp socket, according to an embodiment of the present disclosure;

FIG. 28 is a bottom view of a lamp socket, according to an embodiment of the present disclosure;

FIG. 29 is a perspective view of a lamp cover and the LED lamp assembly of FIGS. 22-23, according to an embodiment of the present disclosure;

FIG. 30 is a cross-sectional view of the lamp cover and the LED lamp assembly of FIG. 29;

FIG. 31 is a cross-sectional view of the lamp cover assembled onto the LED lamp assembly of FIGS. 29-23;

FIG. 32 is a front view of a lamp cover, according to an embodiment of the present disclosure;

FIG. 33 is a top view of the lamp cover of FIG. 32;

FIG. 34 is a cross-sectional view of the lamp cover of FIG. 32;

FIG. 35, is a front view of wires connected to lead frames with electrical connectors, according to embodiments of the present disclosure;

FIG. 36 is a front view of the assembly of FIG. 35 with conformal coating on the electrically-conductive portions;

FIG. 37 is a front view of the assembly of FIG. 36 and another embodiment of a separator, according to an embodiment of the invention;

FIG. 38 is a perspective view of the assembly of FIG. 36 and the separator of FIG. 37, assembled together separator, according to an embodiment of the invention;

FIG. 39 is a cross-sectional view of the assembly of FIG. 38, according to an embodiment of the invention;

FIG. 40 is a perspective view of a separator, according to an embodiment of the present disclosure;

FIG. 41 is another perspective view of a separator, according to an embodiment of the present disclosure;

FIG. 42 is a side view of the separator of FIGS. 40-41;

FIG. 43 is a front view of the separator of FIGS. 40-41;

FIG. 44 is a top view of the separator of FIGS. 40-41;

FIG. 45 is a bottom view of the separator of FIGS. 40-41;

FIG. 46 is a perspective view of the assembly of FIGS. 38-39 and a lamp socket, according to an embodiment of the present disclosure;

FIG. 47 is a perspective view of the assembly of FIGS. 38-39 and a lamp socket, assembled together, according to an embodiment of the present disclosure;

FIG. 48 is front, cross sectional view of the assembly of FIGS. 38-39 and a lamp socket, according to an embodiment of the present disclosure;

FIG. 48A is an enlarged view of a bottom corner of the lamp socket of FIG. 48, depicting a projecting ridge;

FIG. 49 is front, cross sectional view of the assembly of FIGS. 38-39 assembled to a lamp socket, according to an embodiment of the present disclosure;

FIG. 50 is a perspective view of the lamp socket of FIG. 48, according to an embodiment of the present disclosure;

FIG. 51 is a front view of the lamp socket of FIG. 50;

FIG. 52 is another perspective view of the lamp socket of FIG. 50;

FIG. 53 is a top view of the lamp socket of FIG. 50;

FIG. 54 is a front view of the lamp socket of FIG. 50;

FIG. 55 is a cross-sectional view of the lamp socket of FIG. 50;

FIG. 56 is a perspective view of the corrosion-resistant LED assembly of FIG. 47 and a lamp cover, according to an embodiment of the present disclosure;

FIG. 57 is a cross sectional view of the assembly and lamp cover of FIG. 56, according to an embodiment of the present disclosure;

FIG. 58 is a cross sectional view of the assembly assembled with the lamp cover of FIG. 56, according to an embodiment of the present disclosure;

FIG. 59 is a perspective view of the corrosion-resistant LED assembly of FIG. 47 and a threaded lamp cover, according to an embodiment of the present disclosure;

FIG. 60 is a cross sectional view of the assembly and lamp cover of FIG. 59, according to an embodiment of the present disclosure;

FIGS. 61-64 depict embodiments of a corrosion-resistant LED lamp assembly having a combined lamp socket-lamp cover;

FIG. 65 is a perspective view of an embodiment of a corrosion-resistant LED lamp assembly with a threaded lamp cover and a two-piece wire-stabilizer-socket-sealer portion, according to an embodiment of the present disclosure;

FIG. 66 is a perspective view of the embodiment of FIG. 65 in a partially-exploded view and without the lamp cover, according to an embodiment of the present disclosure;

FIG. 67 is a front view of the wire-stabilizer-socket-sealer portion, according to an embodiment of the present disclosure;

FIG. 68 is a perspective view of the wire-stabilizer-socket-sealer portion of FIG. 67;

FIG. 69 is a cross-sectional view of the wire-stabilizer-socket-sealer portion of FIG. 67;

FIG. 70 is a perspective view of an embodiment of a corrosion-resistant LED lamp assembly with a push-in lamp cover and a two-piece wire-stabilizer-socket-sealer portion, according to an embodiment of the present disclosure;

FIG. 71 is a perspective view of the embodiment of FIG. 70 in a partially-exploded view and without the lamp cover, according to an embodiment of the present disclosure;

FIG. 72 is a front view of the wire-stabilizer-socket-sealer portion, according to an embodiment of the present disclosure;

FIG. 73 is a perspective view of the wire-stabilizer-socket-sealer portion of FIG. 72;

FIG. 74 is a cross-sectional view of the wire-stabilizer-socket-sealer portion of FIG. 72;

FIG. 75A is a top view of the wire-stabilizer-socket-sealer portion of FIG. 72;

FIG. 75B is a bottom view of the wire-stabilizer-socket-sealer portion of FIG. 72;

FIG. 76 is a perspective view of an embodiment of a corrosion-resistant LED assembly having a multi-LED lamp, according to an embodiment of the present disclosure;

FIG. 77 is a front view of the multi-LED lamp of FIG. 76, according to an embodiment of the present disclosure;

FIG. 78 is a side view of the multi-LED lamp of FIG. 76, according to an embodiment of the present disclosure;

FIG. 79 is a top view of the multi-LED lamp of FIG. 76, according to an embodiment of the present disclosure;

FIG. 80 is a bottom view of the multi-LED lamp of FIG. 76, according to an embodiment of the present disclosure;

FIG. 81 is a front view of another embodiment of a multi-LED lamp, according to an embodiment of the present disclosure;

FIG. 82 is a front view of yet another embodiment of a multi-LED lamp, according to an embodiment of the present disclosure;

FIG. 83 is a subassembly of the corrosion-resistant LED lamp assembly with multi-LED lamp of FIG. 76;

FIG. 84 is the subassembly of FIG. 83 with conformal coating, according to an embodiment of the invention;

FIG. 85 is a perspective view of the subassembly of FIG. 83 and a separator, according to an embodiment of the invention;

FIG. 86 is a perspective view of the subassembly of FIG. 83 assembled to a separator and wires and a lamp socket, according to an embodiment of the present disclosure;

FIG. 87 is an assembled subassembly of FIG. 86 in cross section, according to an embodiment of the present disclosure;

FIG. 88 is a cross-sectional view of the lamp socket of FIG. 86, according to an embodiment of the present disclosure;

FIG. 89 is a top view of the lamp socket of FIG. 86, according to an embodiment of the present disclosure;

FIG. 90 is a bottom view of the lamp socket of FIG. 86, according to an embodiment of the present disclosure;

FIG. 91 is a circuit diagram of a multi-LED lamp, according to an embodiment of the present disclosure;

FIG. 92 is an electrical circuit diagram of a multi-LED lamp, according to another embodiment of the present disclosure;

FIG. 93 is a schematic diagram of a multi-LED lamp depicting a circuit and component layout, according to an embodiment of the present disclosure;

FIG. 94 is an electrical circuit diagram of a multi-LED lamp that includes a rectifying bridge, according to an embodiment of the present disclosure;

FIG. 95 is another electrical circuit diagram of a multi-LED lamp that includes a rectifying bridge, according to an embodiment of the present disclosure;

FIG. 96 is a schematic diagram of a multi-LED lamp depicting a circuit and component layout, according to another embodiment of the present disclosure;

FIG. 97 is an electrical circuit diagram of a decorative light string, according to an embodiment of the present disclosure;

FIG. 98 is another electrical circuit diagram of a decorative light string, according to an embodiment of the present disclosure;

FIG. 99 is another electrical circuit diagram of a decorative light string, according to an embodiment of the present disclosure;

FIG. 100 is a schematic diagram of a decorative light string, schematically depicting components of the light string, according to an embodiment of the present disclosure;

FIG. 101 is a schematic diagram of another decorative light string, schematically depicting components of the light string, according to an embodiment of the present disclosure;

FIG. 102A is a circuit diagram of an LED bulb or lamp having multiple LEDs, according to an embodiment of the present disclosure;

FIG. 102B is a circuit diagram of another LED bulb or lamp having multiple LEDs, according to another embodiment of the present disclosure;

FIG. 103A is a circuit diagram of an LED bulb or lamp having multiple LEDs and rectifying bridges, according to an embodiment of the present disclosure;

an embodiment of an LED lamp assembly 100 having a cavity-filling sealing material 508 is depicted

FIG. 103B is a circuit diagram of another LED bulb or lamp having multiple LEDs and rectifying bridges, according to another embodiment of the present disclosure;

FIGS. 104-112 depict an embodiment of an LED lamp assembly having a cavity-filling sealing material, according to an embodiment of the present disclosure;

FIGS. 113A-113D depict embodiments of multi-LED bulbs, according to embodiments of the present disclosure;

FIGS. 114-120 depict embodiments of a large-base, large-socket, corrosion-resistant LED lamp assembly, according to embodiments of the present disclosure;

FIG. 121 is a front view of an LED lamp having a sealed glass envelope, according to an embodiment of the present disclosure;

FIG. 122 is front view of a lamp base, according to an embodiment of the present disclosure;

FIG. 123 is a top view of the lamp base of FIG. 122;

FIG. 124 is front view of the LED bulb of FIG. 121 with lamp base and wires, according to an embodiment of the present disclosure;

FIG. 125 is a front view of the assembly of FIG. 124 assembled to a lamp socket, according to an embodiment of the present disclosure;

FIG. 126 is a front view of an LED bulb connected to a pair of wires at connecting joints that may be soldered or welded, according to an embodiment of the present disclosure;

FIG. 127 is front view of the LED assembly of FIG. 126 with an overmolded cover, according to an embodiment of the present disclosure; and

FIG. 128 is a front view of the LED assembly of FIG. 126 with an overmolded cover and lamp base, according to an embodiment of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Light or lamp assemblies used for seasonal decorative lighting applications, such as Christmas lights and other holiday lights typically will be used outdoors and subject to getting rained on, or otherwise getting wet. Lamp assemblies traditionally include a lamp with lamp leads that is inserted into a lamp base for a lamp-base subassembly that is inserted into a lamp socket and connected to a pair of wires. Because of this mechanical assembly, water may penetrate interior portions of the lamp assembly and cause shorting and/or corrosion on conducting parts. Such corrosion may eventually result in lamp failure.

Corrosion-resistant materials can help reduce or slow down corrosion, such as using copper-steel alloy, rather than steel, but will not eliminate corrosion if water penetrates the lamp assembly. Such changes in material are not entirely effective and can be expensive.

Further, light-emitting diode-based lamp assemblies (LED lamp assemblies) which include an anode (positive voltage connection) connected to a first lead and a cathode (negative voltage connection), may be prone to leakage or stray current conduction from the anode to the cathode, which is exacerbated or increased when exposed to water within the lamp assembly. This leakage current causes or increases corrosion on the conductors or lead wires and connectors connected to the anode and cathode lead frames via electrolysis.

Problems with water or moisture intrusion into a lamp assembly can also be increased due to relatively large part/component tolerances that help increase automated manufacturing times, but create gaps or spaces between parts, allowing water intrusion.

Embodiments of the present invention reduce or eliminate water intrusion into a lamp assembly, including LED lamp assemblies, thereby reducing or eliminating corrosion of conductive components of the lamp assembly, including LED lead frames, wire conductors and connectors. Such embodiments may include waterproof or water-resistant, corrosion-resistant lamp assemblies and light strings, as described herein, including in the Figures.

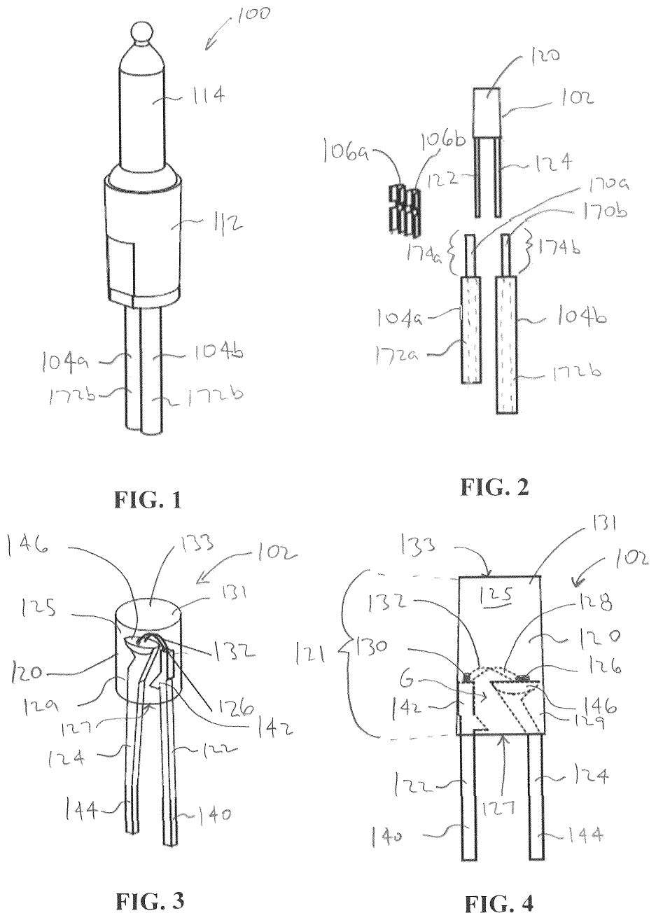

Referring to FIG. 1, moisture-resistant, corrosion-resistant LED lamp assembly 100, according to an embodiment, is depicted. Referring also to FIGS. 2 and 12-14, LED lamp assembly 100 includes LED lamp (or bulb) 102, wires (insulated conductors) 104, including first wire 104a and second wire 104b, conductor-lead-frame connectors 106, including first, conductor-lead-frame connector 106a and second, conductor-lead-frame connector 106b, conformal coating 108, separator device (isolator device) 110, lamp socket 112 and lamp cover or cap 114.

Referring to FIGS. 2-6, LED lamp 102 includes lamp lens 120 (also referred to as a “case” or “housing”), first conductive structure 122, which may be a first-polarity lead frame 122, second conductive structure 124, which may be a second-polarity lead frame 122, light-emitting diode (LED) element 126, first electrical connector 128, optional electrical bypass element 130, and optional second electrical connector 132. Hereinafter, first conductive structure 122 and second conductive structure 124 will be referred to as first-polarity “lead frame” 122 and second-polarity “lead frame” 124, though it will be understood that rather than a lead frame, conductive structures 122 and 124 may comprise other types of conductive structures such as printed conductors on a substrate, wire conductors, metal pins or rods, stamped structures, etched structures, and so on. Conductive structures 122 and 124 may comprise a variety of conductive materials, such as metals, metal alloys, copper, copper alloy, steel, nickel, plated alloys, steel-plated alloys or metals and other such conductive metals and alloys that may or may not be plated. First-polarity conductive structure 122 and second-polarity conductive structure 124 may include die pads for receiving LED dies (chips) or bypass element dies.

Lamp lens 120, in an embodiment comprises a transparent or semi-transparent material, which in an embodiment is an epoxy material. Other materials may include glass, epoxy with glass particles, polycarbonate (PC) or polymethylmethacrylate (PMMA). Lamp lens 120 may be clear, or may comprise a color, such as a color that matches light emitted from LED element 126. The shape of lamp lens 120 as depicted is frustoconical, or a truncated conical shape, though other shapes are contemplated, such as conical, cylindrical, spherical, square, domed, symmetrical, asymmetrical, and so on. In an embodiment, lamp lens 120 includes lower end 129, upper end 131, outer side surface 125, lower surface 127 and upper surface 133. Outer surface 125 which extends circumferentially around lamp lens 120 and may also include lower surface 127 at a lower end 129 of lamp lens 120 which extends perpendicularly to outer surface 125, and which in an embodiment is circular. Lower end 129 is opposite upper end 131 of lamp lens 120.

Referring specifically to FIGS. 3 and 4, first polarity lead frame 122 may be an anode or positive lead frame, comprising a conductive material, which in an embodiment is a metal material. First polarity lead frame 122 includes first or lower lead portion 140 and second upper, head or post portion 142. As described further below, post portion 142 may support or hold electrical element 130.

Second polarity lead frame 124 may be a cathode or negative lead frame, comprising a conductive material, which in an embodiment is a metal material. Second polarity lead frame 124 includes first or lower lead portion 144 and second or upper, head, or anvil portion 146.

Upper portion 146 is separated from upper portion 142 of first-polarity lead frame 122 by a gap G. As described further below, anvil portion 146 may support or hold LED element 126.

LED element 126 may comprise any of a variety of known LED elements and includes an LED semiconductor die or chip. LED element 126 may comprise a single LED chip emitting a single-color light, or may comprise a plurality of LED chips, such as an RGB (red-green-blue) chip. LED element 126 may comprise any of a variety of LED packages, such as an SMD (surface mount device), COB (chip on board), COF (chip on flex), modular, flip chip, and so on. In an embodiment, LED element 126 may also be covered with, or include a primary optic or LED lens (not depicted). In an embodiment, LED element 126 may also include, or be integrated with, an integrated controller (IC) for controlling operation of the LED semiconductor. Embodiments of LED element 126 are described in U.S. Pat. No. 6,921,926, issued Jul. 26, 2005 and entitled “LED Package and the Process Making the Same,” which is incorporated by reference herein in its entirety.

First electrical connector 128 may comprise a first bonding wire that is a thin metal wire or conductor for making an electrical connection between LED element 126 and first polarity lead frame 122.

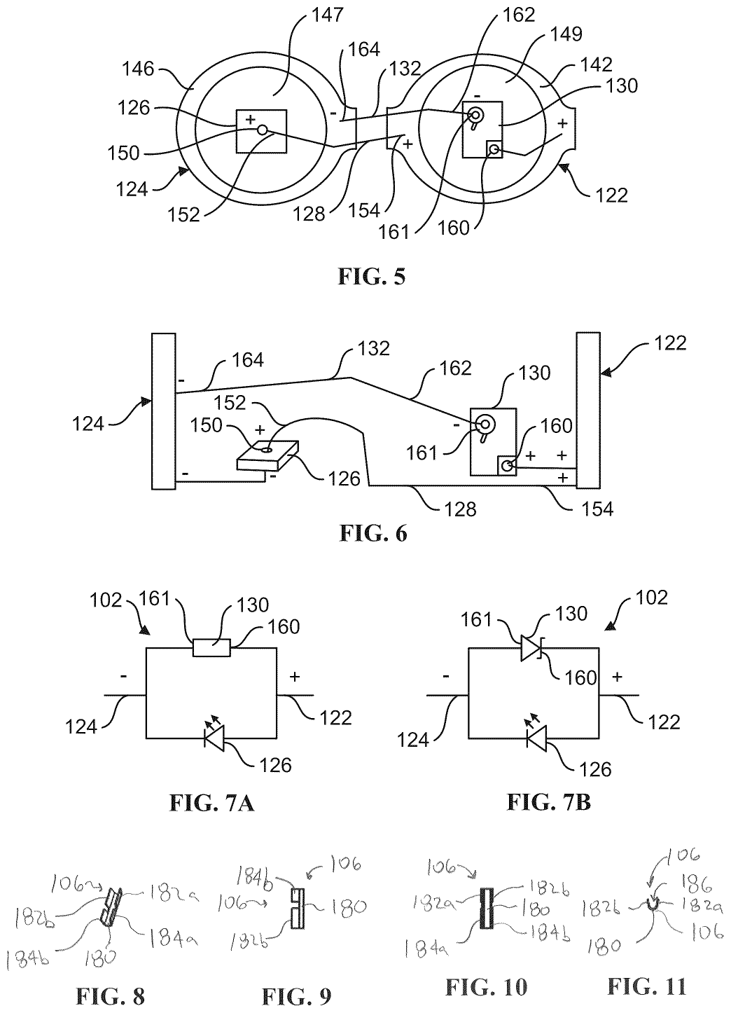

In an embodiment, LED lamp assembly 100 may also include electrical bypass element 130 and corresponding second electrical connector. When present, electrical bypass element 130 may comprise one of a variety of electrical bypass elements electrically connected in parallel to LED element 126, as described further below with respect to FIGS. 5-7B. In an embodiment, bypass electrical element 130 may comprise a Zener diode, LED, resistor or another electrical bypass element, which may be electrically connected in parallel with LED element 126. As described further below, and depicted in FIG. 7, in an embodiment where electrical element 130 comprises a Zener diode, the Zener diode may be electrically connected in reverse polarity.

When LED lamp 102 includes electrical bypass element 130, second electrical connector 132 is included. Second electrical connector may be substantially the same as first electrical connector 130 as described above, which in an embodiment, comprises a bonding wire.

Referring to FIGS. 3-5, in an embodiment, when LED lamp 102 is assembled, LED element 126 is mounted, directly or indirectly, to top portion 146, and in some embodiments, to upper or top surface 147 at an end of top portion 146, of second polarity lead frame 124. In one such embodiment, a cathode portion of LED element 126 is in electrical connection with second polarity lead frame 124 and its top portion 146. LED element 126 may be affixed to second polarity lead frame 124 via any number of known LED attachment methods, including those described in U.S. Pat. No. 3,820,237, issued Jun. 28, 1974 and entitled “Process for Packaging Light Emitting Devices”; U.S. Pat. No. 9,099,332, issued Aug. 4, 2015 and entitled “Lead frame for light emitting device package, light emitting device package, and illumination apparatus employing the light emitting device package”, which are herein incorporated by reference in their entireties.

In an embodiment, LED element 126 is substantially centered on top surface 147 as depicted in FIG. 5. In other embodiments, LED element 126 may be displaced laterally or longitudinally from a center of top surface 147, thereby leaving space for bonding wire 132 to be connected to top portion 146 of second polarity lead 124.

First electrical connector or bonding wire 128 at first end 152 is electrically connected to an anode portion 150 of LED element 126, and is electrically connected to first polarity lead frame 122 at second end 154 of bonding wire 128. In an embodiment, second end 154 of bonding wire 128 is connected directly to top or post portion 142.

In an embodiment, electrical bypass element 130 is affixed or connected to top or post portion 142 of first polarity lead 122. First portion 160 of electrical bypass element 130 is electrically connected to top or post portion 142 of first polarity lead 122.

In an embodiment, electrical bypass element 130 is substantially centered on top surface 149 as depicted in FIG. 5. In other embodiments, electrical bypass element 130 may be displaced laterally or longitudinally from a center of top surface 149, thereby leaving space for end 154 of bonding wire 128 to be connected to top portion 142 of first polarity lead 122.

Second electrical connector or bonding wire 132 at first end 162 is electrically connected to second portion 161 of electrical bypass element 130 and is electrically connected to second polarity lead frame 124 at second end 164. In an embodiment, second end 164 of bonding wire 132 is connected directly to top or post portion 146.

Lens 120 encapsulates portions of first and second polarity lead frames 122, 124, LED element 126, first electrical connector 128, electrical bypass element 130 (when present) and second electrical connector 132 (used with electrical bypass element 130) to form an assembled LED lamp 102. The portion of LED lamp 102 that includes lens 120 encapsulating top portions of lead frames 122 and 124, including post and anvil portions 142, 146, LED element 126, electrical connectors 128 and 132 (when present), and electrical bypass element 130 (when present), i.e., all portions of LED lamp 102 except for portions of lead frames 122, 124 protruding out from lens 120, will be referred to as upper LED lamp portion 121 for the sake of explanation.

Further, and as depicted in FIGS. 5-7, first polarity lead frame 122 may have a positive polarity, and second polarity lead frame 124 may have a negative polarity, such as would be used in a typical direct current (DC) operation of LED lamp assembly 100. In other embodiments, and depending on desired operation of LED element 126, the polarities may be reversed, i.e., first polarity lead frame 122 may have a positive polarity, and second polarity lead frame 124 may have a negative polarity.

Referring specifically to FIGS. 7A and 7B, schematic diagrams of LED lamp 102 are depicted. In FIG. 7A, electrical bypass element 130 as a generic device electrically connected in parallel with LED element 126, with an anode of LED element 126 electrically connected to first polarity lead frame 122 and first portion of electrical bypass element 160. A cathode of LED element 126 and second portion 161 are electrically connected to one another and second polarity lead frame 124. As described above, electrical bypass element 130 may comprise one or more of a variety of devices, such as a resistor, Zener diode, other diode, and so on. In an embodiment wherein electrical bypass element 130 is a resistor, first portion 160 and second portion 161 of electrical bypass element 130 are respective resistor leads.

In the embodiment of FIG. 7B, electrical bypass element 130 comprises a Zener diode. In this embodiment, Zener diode 130 is reverse biased.

Advantages of having small electrical bypass elements 130 located within LED lamp 102, rather than located external to LED lamp 102 and its lens 120 are discussed further below with respect to decorative lighting strings that include multiple LED lamp assemblies 100.

Referring to FIGS. 1 and 2, LED lamp assembly 100 includes first wire 104a and second wire 104b. Each wire 104 includes conductor portion 170 and insulation portion 172, such that first wire 104a includes first conductor portion 170a and first insulation portion 172a, and second wire 104b includes second conductor portion 170b and second insulation portion 172b. Insulation portions 172 cover portions of conductor portions 170, though each wire 104 and conductor portion 170 includes a bare or stripped or uninsulated portion 174, such that first wire 104a includes uninsulated conductor portion 174a and second wire 104b includes uninsulated conductor portion 174b.

Referring to FIGS. 2 and 8-11, an embodiment of a conductor-lead-frame connector 106 is depicted. In an embodiment, and as depicted in FIG. 2, LED lamp assembly 100 may include a pair of conductor-lead-frame connectors, including first conductor-lead-frame connector 106a and second conductor-lead-frame connector 106b. In an embodiment, each conductor-lead-frame connector 106 may comprise a conductive material, such as metal that may include copper, copper alloy, steel, nickel or other metals or metal alloys.

In an embodiment, and as depicted each conductor-lead-frame connector 106 may be a crimp connector configured to crimp to, and thereby mechanically and electrically connect an uninsulated conductor portion 174 to one of first lead frame 122 or second lead frame 124, e.g., first conductor-lead-frame connector 106a may mechanically and electrically connect first uninsulated conductor portion 174a to lead frame 122 and second conductor-lead-frame connector 106b may mechanically and electrically connect second uninsulated conductor portion 174b to lead frame 124.

In the embodiments depicted, and unlike known decorative-lighting structures, a conductor-lead-frame connector 106 mechanically connects to a wire 104 only by connecting to or attaching to an uninsulated conductor portion 174 of an insulated wire 104, and without crimping to an insulated portion 172. In contrast, known decorative lighting lamp assemblies typically crimp to an insulated portion of a wire, an uninsulated portion of the wire, and to the bulb lead. Because conductor-lead-frame connectors 106 are made of a conductive, metal material, they can be prone to corrosion when exposed to moisture and leakage current between opposite polarity conductive or live lamp components.

In an embodiment, and as depicted, each conductor-lead-frame connector 106 includes main or body portion 180, first or upper lateral projections or extensions 182, including lateral projections 182a and 182b, second or lower lateral projections or extensions 184, including lateral projections 184a and 184b. In an embodiment, body portion 180 extends longitudinally, and first and second projections 182 and 184 extend or project laterally or transversely to body portion 180. In an embodiment, each conductor-lead-frame connector 106 defines a longitudinally-extending conductor-lead-frame receiving channel 186 configured to receive a portion of uninsulated conductor portion 174 of a wire 104, such as uninsulated conductor portion 174a or 174b, and a portion of a lead frame, such as first lead frame 122 or second lead frame 124.

In another embodiment, wires 104a and 104b may be respectively mechanically and electrically connected to first lead frame 122 and second lead frame 124 via soldering. In one such embodiment, LED lamp assembly 100 may not include conductor-lead-frame connectors 106 at all, and may rely on the solder joints to make the connections between wires and lead frames. In such an embodiment, the absence of conductor-lead-frame connectors 106 and reliance of solder joint connections may eliminate a potential point of corrosion, i.e., corrosion of conductor-lead-frame connectors 106.

In one embodiment, LED lamp assembly may include conductor-lead-frame connectors 106 which make respective connections between wires 104a, 104b and lead frames 122, 124, but also include soldering to ensure a strong mechanical and reliable electrical connection between wires 104 and lead frames 122, 124.

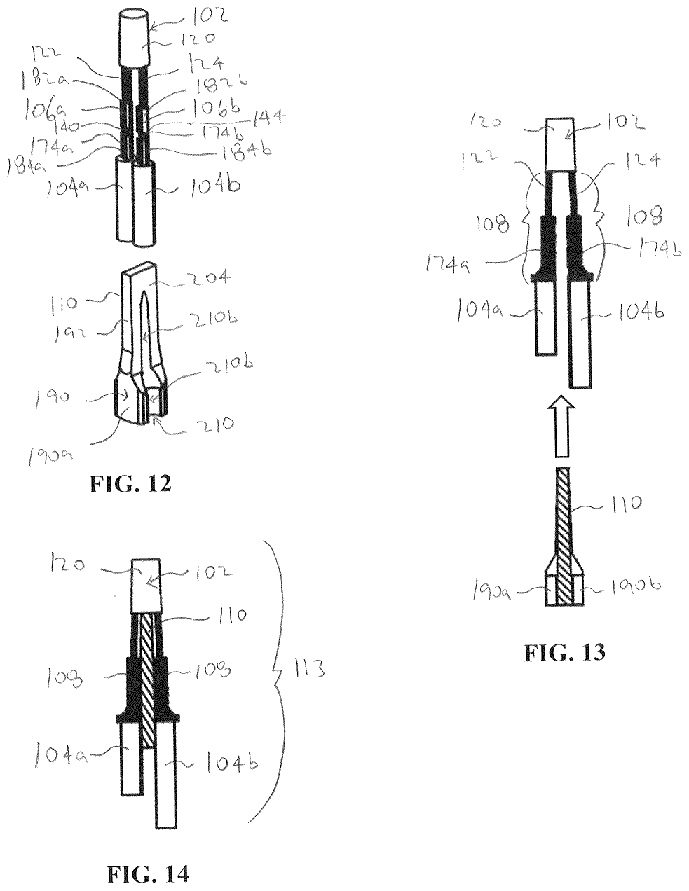

Referring to FIGS. 12-14, an embodiment of a subassembly 113 of LED lamp assembly 100 comprising LED lamp 102, wires 104a, 104b, conductor-lead-frame connectors 106a, 106b, conformal coating 108 and separator or isolator device 110, is depicted.

Referring specifically to FIG. 12, in an embodiment, uninsulated conductor portion 174a of wire 104a and first lead portion 140 of first polarity lead frame 122 are received into channel 186 of conductor-lead-frame connector 106a. Connector 106a is crimped onto uninsulated conductor portion 174a and first lead portion 140 such that projection portions 182a and 182b are bent inwardly toward body portion 180, thereby holding uninsulated conductor portion 174a and first lead portion 140 in contact with one another, or in contact with body portion 180 to make a mechanical and electrical connection, and such that projection portions 184a and 184b are bent inwardly toward body portion 180, thereby also holding uninsulated conductor portion 174a and first lead portion 140 in contact with one another, or in contact with body portion 180 to make a mechanical and electrical connection. Connector 106b is similarly crimped onto uninsulated conductor portion 174b and first lead portion 144 to make a mechanical and electrical connection between uninsulated conductor portion 174b and first lead portion 144.

Referring also to FIGS. 2-3, in an embodiment, first lead portion 140 of first polarity lead frame 122 may be longer than either or both of conductor-lead-frame connector 106a and uninsulated conductor portion 174a. Similarly, second lead portion 144 of second polarity lead frame 124 may be longer than either or both of conductor-lead-frame connector 106b and uninsulated conductor portion 174b. As explained further below, having longer lead frame portions 140 and 144 may be advantageous in extending LED element 126 and lens 120 outwardly and away from lamp socket 112 for better illumination.

In an alternate embodiment first lead portions 140, 144 are as short as possible so as to reduce a size of LED bulb 102 and LED bulb assembly 100.

In an embodiment, conductor-lead-frame connectors 106 are located closer to insulated portions 172 as compared to lens 120. In one such embodiment, conductor lead frame connectors 106 are positioned adjacent to their respective insulated portion 172.

Referring also to FIG. 13, conformal coating 108 covers or coats all, or substantially all, portions of exposed conductive portions of subassembly 113, including all portions of first polarity lead frame 122 external to (outside of) lens 102, all portions of second polarity lead frame 124 external to lens 120, uninsulated conductor portions 174a and 174b, conductor-lead-frame connector 106a and conductor-lead-frame connector 106b. In an embodiment, and as depicted, conformal coating 108 may also cover or coat a portion of insulation portions 172a and 172b of wires 104a and 104b, respectively, to ensure that all portions of uninsulated conductor portions 174 are coated.

Conformal coating 108 may comprise any of a variety of coatings that conform to the surface of the various exposed conductive, metal components of the subassembly 113 of LED bulb assembly 102, including uninsulated metal conductor portions 174, metal conductor-lead-frame connectors 106 and portions of lead frames 122 and 124, and protect such components from moisture and subsequent corrosion. In an embodiment, conformal coating 108 is initially a liquid when applied, then forms a film over the coated components, protecting the components from environmental conditions, and particularly moisture. In an embodiment, conformal coating 108 is a polymeric film-forming substance. In other embodiments, conformal coating 108 may comprise urethane, epoxy acrylic, or silicone, which may be in epoxy form, or may comprise parylene, though other materials are contemplated, such as ultraviolet (UV) light-cured adhesive or sealant, or AB gel, AB glue or epoxy. In an embodiment conformal coating 108 forms a 24 to 250 μm thick coating. In other embodiments, conformal coating 108 may form a significantly thicker coating in order to penetrate and fill substantially all voids formed from making the connections described above.

Separator, also referred to as an isolator, is configured to be inserted between the coated first and second polarity electrical components. In other words, separator 110 physically separates the first and second polarity electrical components outside of lens 120, and electrically isolates them from each other. More specifically, isolator 110 is positioned between wires 104a and 104b, between uninsulated conductor portions 174a and 174b, between terminals 106a and 106b, and between first polarity lead frame 122 and second polarity lead frame 124 to prevent unwanted electrical connection, such as very small stray current flow that might occur when the electrical components are wet, between the first and second polarity electrical components.

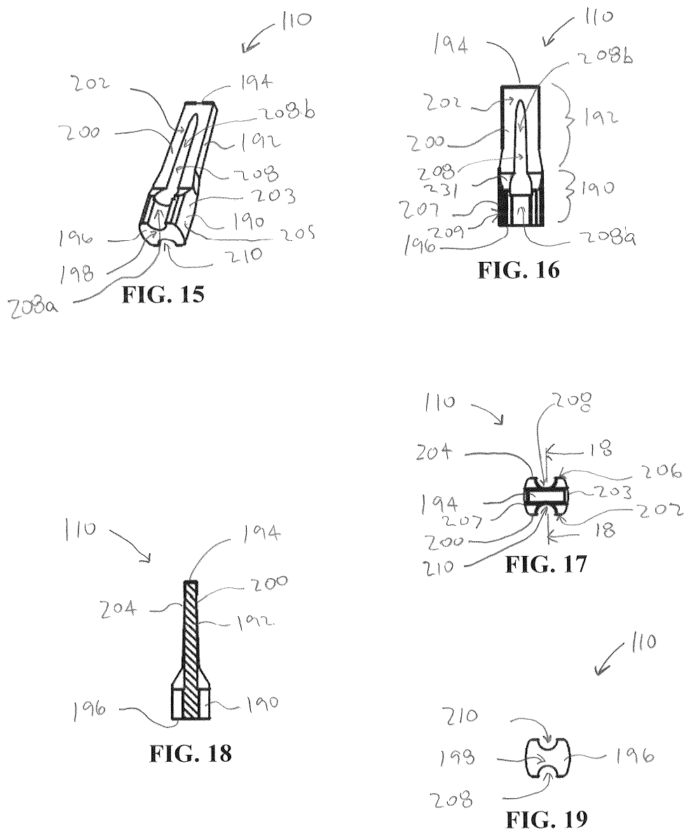

Referring to FIGS. 12 and 15-19, an embodiment of separator 110 is depicted. FIG. 12 depicts a perspective view of separator 110; FIG. 15 depicts another perspective view of separator 110; FIG. 16 depicts a front view of separator 110; FIG. 17 depicts a top view of separator 110; FIG. 18 depicts a right-side sectional view of separator 110; and FIG. 19 depicts a bottom view of separator 110. Though not explicitly depicted, it will be understood that a rear side view of separator 110 is the same as FIG. 16.

In an embodiment, separator 110 comprises an integral component or device which facilitates easy assembly of LED lamp assembly 100. In other embodiments, separator 110 may comprise multiple components, rather than a single, integral component. Separator 110 may comprise one or more of a variety of materials, including polymer materials, including, but not limited to, polyvinylchloride (PVC), polypropylene (PP), polycarbonate (PC), polyethylene (PE), and others.

In an embodiment, and as depicted, separator 110 includes first or lower portion 190, second or upper portion 192, first or upper end 194, second or bottom end 196 with bottom surface 198, first or front side 200 with first or front surface 202, and second or rear side 204 with second or rear surface 206.

In the depicted embodiment, first portion 190 is adjacent to, and integrally connected with second portion 192.

First side 200 defines first channel 208 which includes first lower or wire-insulation-receiving channel portion 208a and first upper or conductor-receiving channel portion 208b. First lower or wire-insulation-receiving channel portion 208a, in an embodiment, is in communication with first upper or conductor-receiving channel portion 208b, such that channel 208 is contiguous. First wire-insulation-receiving portion 208a is sized and configured to receive a portion of insulated portion 172a of wire 104a; first conductor-receiving channel portion 208b is sized and configured to receive portions of one or more of wire 104a uninsulated portion 174a, first polarity lead frame 122, and electrical connector 106a, all or some of which may be coated with conformal coating 108.

Second side 204 is substantially the same as first side 200. In an embodiment, second side 204 defines second channel 210 which includes second lower or wire-insulation-receiving channel portion 210a and second upper or conductor-receiving channel portion 210b. Second lower or wire-insulation-receiving channel portion, in an embodiment, is in communication with second upper or conductor-receiving channel portion 210b, such that channel 210 is contiguous. Second wire-insulation-receiving portion 210a of second channel 210 is sized and configured to receive a portion of insulated portion 172b of wire 104b; second conductor-receiving channel portion 210b is sized and configured to receive portions of one or more of wire 104b uninsulated portion 174b, second polarity lead frame 124, and electrical connector 106b, all or some of which may be coated with conformal coating 108.

Third side 203 of separator 110, in an embodiment, forms a surface 205, which may be arcuate or curved, and which in an embodiment may be convex; fourth side 207 of separator 110, in an embodiment, forms a surface 209, which may be arcuate or curved, and which in an embodiment may be convex.

In addition to separating or isolating the electrically-conductive components described above, separator 110 also improves the mechanical connection between wires 104 and lamp socket 112, preventing, or minimizing the chances of, wires 104 being pulled out of socket 112. The tight fit of insulated wire portions 172 in channels 208 and lamp socket 112 increases the pull force required to pull wires 104 out of socket 112.

In an embodiment that further improves “pull force”, i.e., increases the amount of pull force required to pull wires 104 from lamp socket 112, lamp socket 112 may include a circumferential groove in inside surface 228 of lamp socket 112 that is configured to receive a circumferential complementary ridge or projection extending radially from lower portion 190 of separator 110. A snap-fit connection is thereby formed when the separator ridge or projection is fit into the complementary lamp socket groove.

Referring again to FIGS. 12-14, when assembled as subassembly 113 depicted, coated conductive portions 122, 124, 174, and 106 as well as wire insulation portions 172 are received into channels 208 and 210 of separator 110, which helps hold them in position relative to separator 110 and each other. This also further insulates conductive components at the first side 202 (122, 174a, 106a) from conductive components on the second side 204 (124, 174b, 106b), thereby further reducing any chance of leakage current, possibly due to moisture, from one side to another and between sets of conductive components.

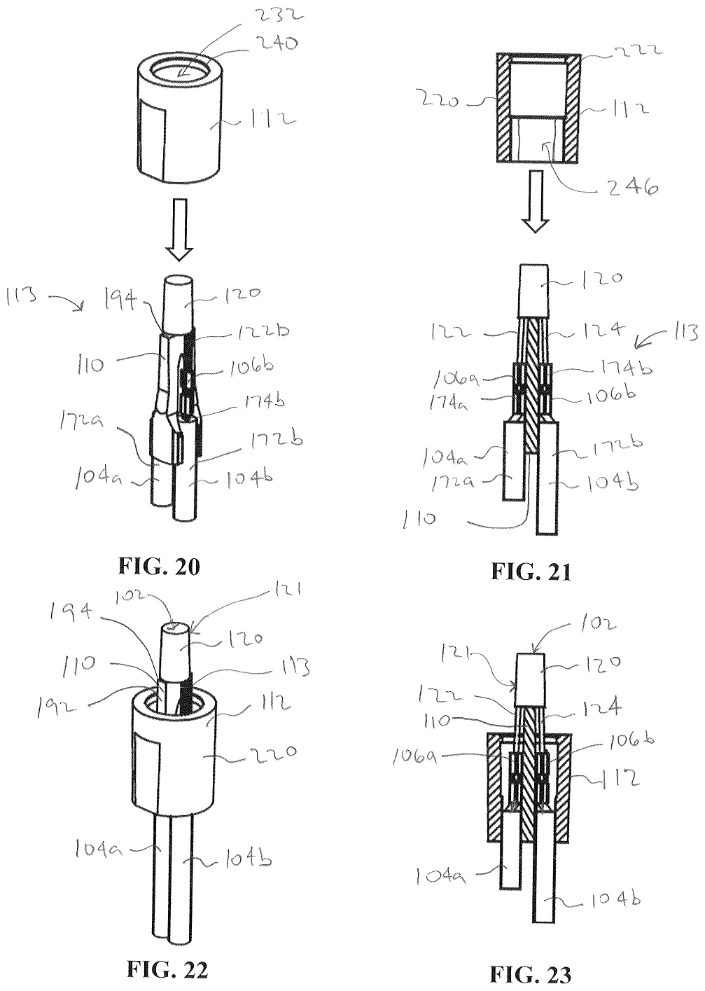

Referring to FIGS. 20-23 an embodiment of socket 112 is depicted assembled with subassembly 113 of FIGS. 12-14.

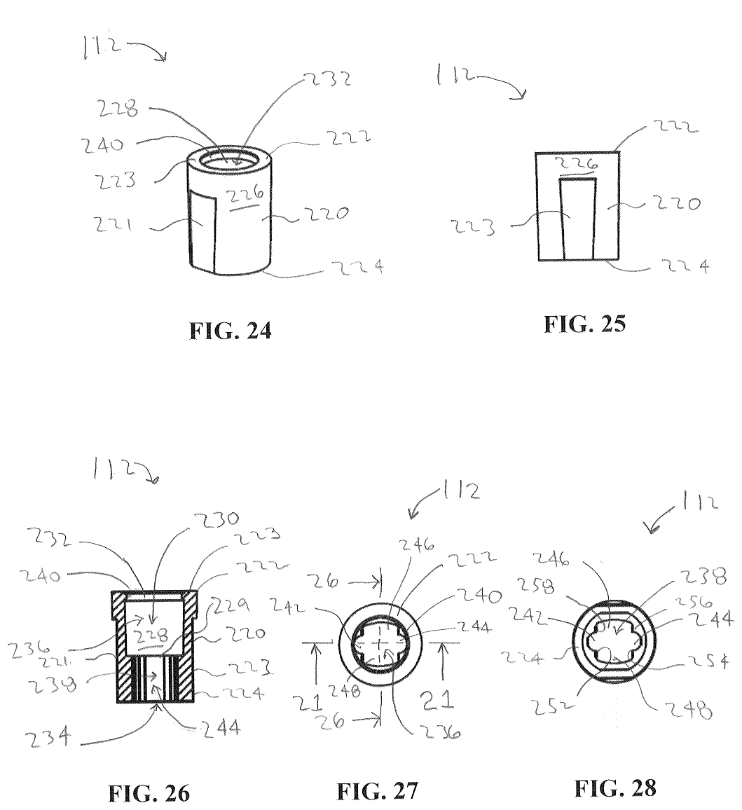

Referring to FIGS. 24-28, an embodiment of socket 112 is depicted. FIG. 24 is a perspective view of socket 112; FIG. 25 is a front view of socket 112; FIG. 26 is a sectional view of socket 112 based on FIG. 28; FIG. 27 is a top view of socket 112; and FIG. 28 is a bottom view of socket 112. In an embodiment, socket 112 may comprise one or more of a variety of materials, including polymer materials, including, but not limited to, polyvinylchloride (PVC), polypropylene (PP), polycarbonate (PC), polyethylene (PE), and others.

In the embodiment depicted, socket 112 includes main or body portion 220 with opposing flattened surfaces 221 and 223, first or top end 222 with top surface 223, second or lower end 224, outside side surface 226 and inside surface 228. In an embodiment, and as depicted, a length of lamp socket 112 (top to bottom) may be less than a length of separator 110, such that when separator 110 is located at lower end 224 of socket 112, top end 194 projects outward and away from lamp socket 112 and is positioned outside of cavity 230. Body portion 220 defines receiving cavity 230, first or top opening 232 and second or bottom opening 234. Receiving cavity 230 includes first or upper cavity portion 236 and second or lower cavity portion 238. Upper cavity portion 236 is in communication with lower cavity portion 238. In an embodiment, lower cavity portion 238 receives lower portion 190 of separator 110 and insulated portions 104a and 104b of wires 104; upper cavity portion 236 receives portions of upper portion 192 of separator 110, first and second polarity lead frames 122 and 124, and electrical connectors 106, with conformal coating 108.

Body portion 220 and top end 222, in an embodiment, form cover-retention ring or lip 240, which may be an annular ring or lip, which defines top opening 232; top opening 232 opens into top cavity 236. Upper cavity 236, in an embodiment, is generally cylindrical with a circular cross-section, and except for an upper portion defined by cap-retention ring 240, may define a substantially constant diameter from top to bottom. In other embodiments, top cavity 236 may define a tapering diameter, such as a smaller diameter nearest a bottom portion and a larger diameter nearest a top portion of body 220, such that upper cavity 236 forms a conical shape. In other embodiments, upper cavity 236 may form an oval or other cross-sectional shape (other than the circular cross-sectional shape depicted).

Lower end 224 and lower cavity 238 include and define structure for receiving and containing lower portion 190 of separator 110 and wires 104. More specifically, inside surface 228 of lower cavity 238 is shaped to conform to the shape of lower portion 190. More specifically, lower end 224 and lower cavity 238 define a pair of opposing wire-receiving grooves or channels 242 and 244. Wire-receiving groove 242 extends longitudinally (lower-upper) inside body portion 220 and is configured to receive a portion of first wire 104a, including a portion of insulated portion 172a, that is not received into separator 110. Wire-receiving groove 244 extends longitudinally (lower-upper) inside body portion 220 and is configured to receive a portion of first wire 104b, including a portion of insulated portion 172b that is not received into separator 110. In an embodiment, each of grooves 242 and 244 are formed by curved portions of inside surface 228 and may form arc or semi-circular shape in cross section (in a plane perpendicular to wires 104).

Lower end 224 and lower cavity 238 also define a pair of opposing lower-separator-receiving portions 246 and 248, which may be grooves or channels, configured to receive front and rear portions 190a and 190b of lower portion 190 of separator 110. Each of lower-separator-receiving portions 246 and 248 extend longitudinally within body 220 along surface 228 and form a curved or arc shape in cross section (as seen in FIGS. 27 and 28).

Lower end 224 and body 220 may include multiple ridges that form the boundaries between adjacent pairs of a wire-receiving groove and a lower-separator-receiving portion. In an embodiment, body portion 220 includes four longitudinally or lower-upper extending ridges 252, 254, 256 and 258.

Referring again to FIGS. 20-21, for assembly, lamp socket 112 is coupled to subassembly 113 that includes separator 110 attached to wires 104, electrical connectors 106, first and second polarity lead frames 122, 124 and conformal coating 108. In an embodiment, and as depicted in FIGS. 21-22, during assembly, lower end 224 of lamp socket 112 is moved in a direction toward lens 120 of subassembly 113. Receiving cavity 230 of lamp socket 112 receives portions of subassembly 113. In an embodiment, and as depicted in FIGS. 22 and 23, with the exception of lower portions of lead frames 122 and 124, lamp 102 is positioned entirely outside of (and above) lamp socket 112. In such an embodiment, lens 102, LED element 126, bypass element 130, head or post portion 142 and top or anvil portion 146 are positioned outside of, and displaced axially from lamp socket 112. Portions of separator 110, including top end 194, also project outside of lamp socket 112.

All or portions of insulated portions 172 of wires 104, and lower portion 190 of separator 110 may be positioned in lower cavity 238. Electrical terminals 106 and uninsulated wire portions 174 may be completely or substantially positioned in upper cavity 236, along with portions of separator 110.

More specifically with respect to the fitting of separator 110 and wires 104 to lamp socket 112, and referring to FIGS. 15-19 for separator 110 details, to FIGS. 26-28 for lamp socket 112 details, and to FIGS. 20-23 for fitting of wires 104 to separator 110, lower portion 190 of separator 110 is received into lower cavity 238. Third side 203 of separator 110 is fit into complementary lower-separator-receiving portion 246 such that surface 205 is adjacent and in contact with a lower portion of inside surface 228 of lamp socket 112. Fourth side 207 of separator 110 is fit into complementary lower-separator-receiving portion 248 such that surface 209 is adjacent and in contact with a lower portion of inside surface 228 of lamp socket 112. In an embodiment, lower portion 190 is fit tightly into lower cavity 238 of lamp socket 112, such as via a friction fit.

In an embodiment, lamp socket 112 may include a pair of opposing edges 229 that abut separator 110, such as at sloped portion 231, to limit upward axial movement of separator 110 through cavity 230.

A portion of insulated wire portion 172a that protrudes from wire-insulation-receiving channel portion 208a is received into wire-receiving channel 242; a portion of insulated wire portion 172b that protrudes from wire-insulation-receiving channel portion 210a is received into wire-receiving channel 244.

Referring specifically to FIGS. 22-23, in an embodiment, subassembly 113 with conformal coated LED bulb 102 attached to wires 104 and separator 110 is securely fit into lamp socket 112. In this embodiment, upper LED lamp portion 121, including lens 120 encasing LED element 126 and bypass element 130 (also see FIG. 4), are located fully outside and away from lamp socket 112. Positioning upper LED lamp portion 121 above lamp socket 112. Positioning upper LED lamp portion 121 above lamp socket 112 advantageously allows light emitted from LED lamp 102 and its lamp lens 120 to be emitted through lens surfaces 125, 127 and 129 with limited or no obstruction from lamp socket 112.

Further, the construction of lamp subassembly 113 with socket 112 isolates opposite polarity electrical components, and minimizes or eliminates paths or channels that moisture might otherwise travel to cause leakage current between electrical components. More specifically, upper portion 192 of separator 110 is between first polarity lead frame 122 and second polarity lead frame 124. Top end 194 of separator 110, in an embodiment, abuts lower surface 127, closing off a potential moisture-migration path along lower surface 125 of lens 120 and further isolating first polarity lead frame 122 from second polarity lead frame 124.

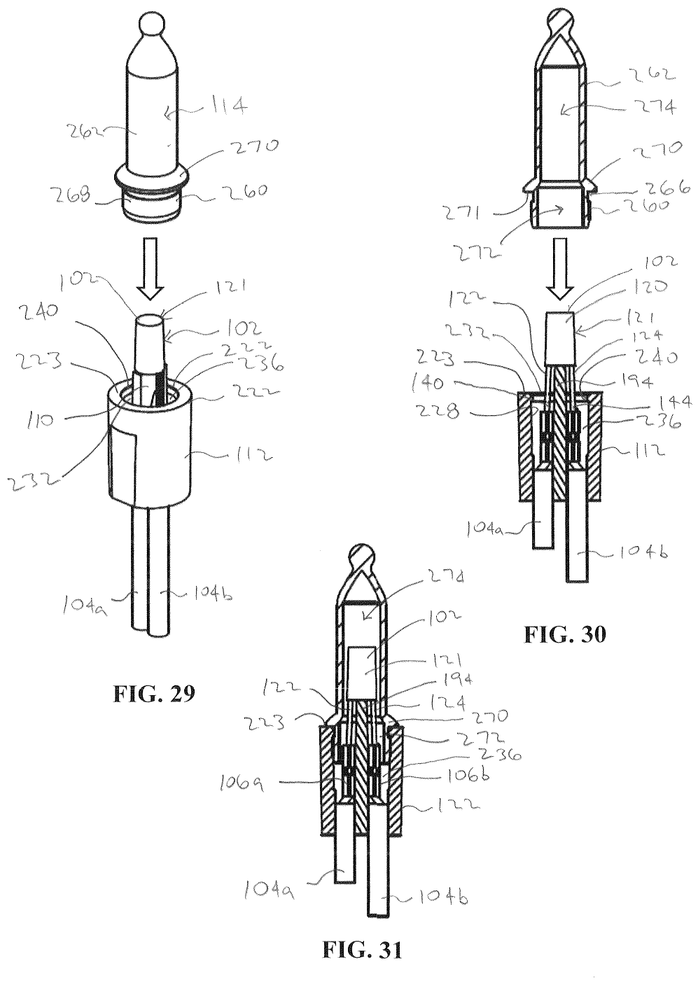

Referring to FIGS. 29-34, lamp cover (also referred to as a lamp cap) 114 assembled into LED lamp assembly 100 is depicted.

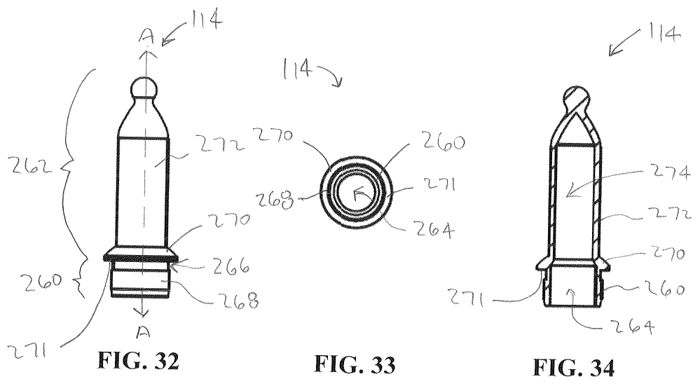

Referring specifically to FIGS. 32-34, in an embodiment, lamp cover 114 may be made of one or more transparent, semi-transparent or translucent materials through which light emitted from LED element 126 is transmitted. Such materials may include glass, polycarbonate (PC) or other polymer materials. In the depicted embodiment, lamp cover is generally cylindrical, though other shapes are contemplated, including spherical, domed, teardrop, candelabra, and so on.

In an embodiment, lamp cover 114 includes lower portion 260 configured to be received into upper cavity portion 236 of lamp socket 112 and upper portion 262 configured to reside external to lamp socket 112.

Referring specifically to FIG. 33, which is a bottom view of lamp cover 114, lower portion 260 in the depicted embodiment is substantially circular in cross section, and is generally shaped and formed to fit, in some cases tightly, into lamp socket 112. Referring also to FIGS. 32 and 34, lower portion 260 defines lower cavity 264 configured to receive portions of LED lamp assembly 100, and socket-engagement channel 266. Socket engagement channel 266 is circumferentially extends around an exterior portion of lower portion 260 forming a ring shape. In an embodiment, lower portion 260 may also include socket-engagement portion, band or ring 268 which has a larger outside diameter as compared to an outside diameter of lower portion 260 at engagement channel 266 to as to engage inner surface 228 of lamp socket 112. In an embodiment, socket engagement channel 266 is formed or defined by flange portion 270 of upper portion 262 (described below), an outer surface of lower portion 260 and socket-engagement band 268.

Still referring to FIGS. 42-34, upper portion 262 of lamp cover 114, in an embodiment, includes flanged portion 270 with lower surface 271 and body portion 272, and defines upper cavity 274. Flanged portion 270 is generally located between lower portion 260 and body portion 272, and projects radially from a central upper-lower or vertical axis A extending through a center of lamp cover 114, and circumferentially around the outside of reflector 114.

Referring specifically again to FIGS. 29-31, lamp cover 114 is assembled to lamp socket 112. In an embodiment, lamp cover 114 is moved axially toward lamp socket 112 through top opening 232 and lower portion 260 is received into upper cavity portion 236. Lower surface 271 of flanged portion 270 is seated on top surface 223 of top end 222, thereby closing another potential pathway for water or moisture to enter lamp socket 112 through socket top opening 232. Cover-retention ring 240 is received into socket-engagement groove or channel 266. The fitting of cover retention ring 240 into channel 266 may comprise a type of interlocking fit, such as a snap fit. In an embodiment, socket-engagement band 268 abuts inside surface 228 of lamp socket 112, assisting with holding cover 114 tightly to lamp socket 112 via friction. The fitments of the various portions of cover 114 to lamp socket 112 prevents or minimizes opportunities for water to enter lamp socket 112 through top opening 232, thereby reducing the chances of leakage current between differing polarity components, such as between first and second polarity lead frames 122 and 124, between conductive portions of wires 104, and their respective connected electrical connectors 106.

In this configuration, upper lamp portion 121 with lamp lens 120 and LED element 126 are positioned above lamp socket 112 and within upper cavity 274, as are some portions of first and second lead frames 122, 124, and top end 194 of separator 110. Lower portions of first lead portion 140 and second lead portion 144 are located within upper cavity 236 of lamp socket 112, as are electrical connectors 106a and 106b. The location of electrical connectors 106 inside lamp socket 112 differs from known LED lamp assemblies and advantageously keeps these conductive components inside lamp socket 112, thereby reducing the risk of electric shock to a user, and improving aesthetic appearance. Location of the electrical connectors 106 and electrical connections of lead frames 122, 124, wires 104 and electrical connectors 106, such as by crimping, etc., inside lamp socket 112 further reduces the possibility of outside moisture causing leakage between lead frames and opposite polarity components of LED lamp 102.

The embodiment of LED lamp assembly 100 depicted and described with respect to FIGS. 1-34 provides a waterproof, or at least water-resistant device that prevents or minimizes moisture from reaching electrically-conductive components of lamp assembly 100, thereby minimizing leakage current between opposite polarity components, e.g., between first polarity lead frame 122 connected to electrical connector 106a and uninsulated wire portion 174a and second polarity lead frame 124 connected to electrical connector 106b and uninsulated wire portion 174b.

The present disclosure includes variations of the embodiment of LED lamp assembly 100 as described above with respect to FIGS. 1-34.

Referring to FIGS. 35-58, another embodiment of LED lamp assembly 100 is depicted. In this embodiment, lamp assembly is substantially similar to the embodiment of FIGS. 1-34 with the primary exception of the way that the lower portion of LED assembly is sealed, and corresponding differences in lamp socket 112 and separator 110 that facilitate that sealing. Same reference numerals for components that are substantially the same between the embodiments will be used, with different reference numerals used for components that are changed.

Referring to FIG. 35, first uninsulated portion 174a of wire 104a is electrically and mechanically connected to first polarity lead frame 122 of LED lamp 102 with first electrical connector 106a. Second uninsulated portion 174b of wire 104b is electrically and mechanically connected to second polarity lead frame 124 of LED lamp 102 with second electrical connector 106b. In this depiction, LED lead frames 122 and 124 are depicted as being somewhat shorter than lead frames 122 and 124 as depicted in FIGS. 1-34, which results in upper LED lamp 121 not extending as far out of lamp socket 112 as compared to the embodiment of FIGS. 1-34 (also compare FIGS. 23 and 58). It will be understood that lengths of LED lead frames 122 and 124, as well as lengths of sockets 112 and separators 110 may vary in order to vary the extent to which upper LED lamp assembly 121 is positioned out and away from lamp socket 112. In the embodiment of FIGS. 1-34, upper LED lamp assembly 121 is positioned further away from lamp socket 112, thereby maximizing light output; in the embodiment of FIGS. 35-58, upper LED lamp assembly 121 is located closer to lamp socket 112, which may allow reduction in the lengths of separator 110 and socket 112, thereby reducing material costs for LED lamp assembly 100.

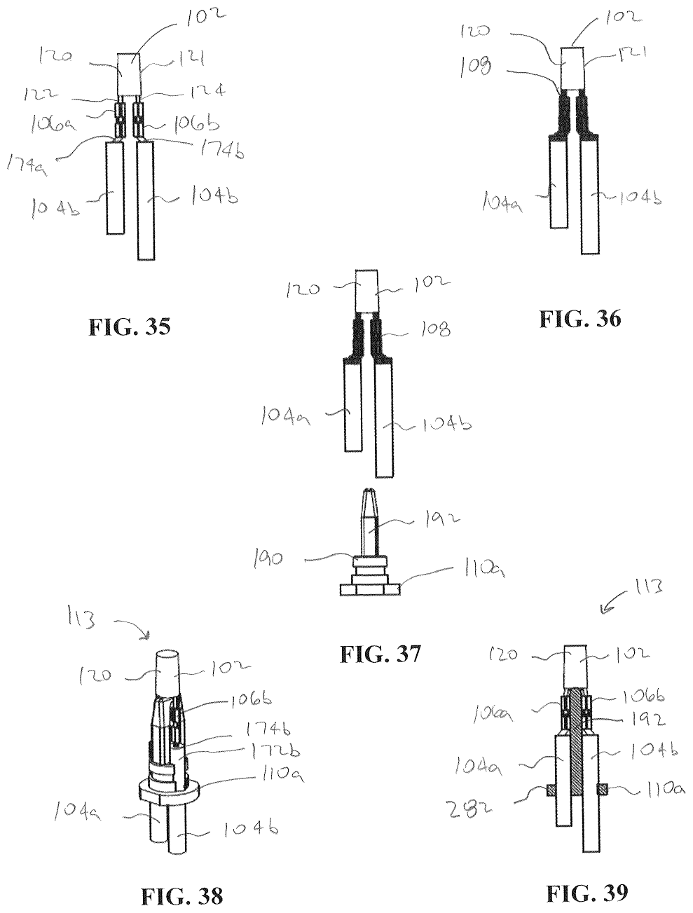

Referring also to FIG. 36, lead 108 is applied to exposed conductive components, namely, uninsulated portions 174, lead frames 122, 124, and electrical connectors 106, as also described above with respect to FIGS. 12-14.

Referring to FIGS. 37-39, an embodiment of separator 110, which for the purposes of description of FIGS. 35-58 will be referred to as separator 110a due to differences with separator 110 described above. Similar to the embodiment of separator 110 described above, separator 110a also performs the function of stabilizing wires 104 and isolating first polarity electrical components from second polarity electrical components.

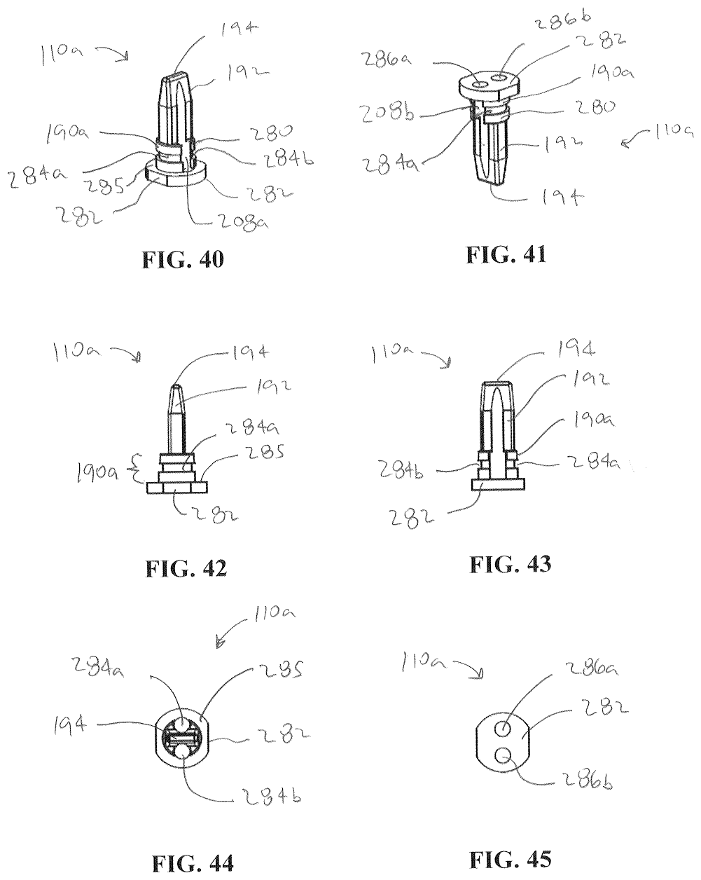

Referring also to FIGS. 40-45, an embodiment of separator 110a is depicted. In this embodiment, separator 110 includes lower portion 190a and upper portion 192 with upper end 194. Upper portion 192 is substantially similar to upper portion 192 of separator 110, though lower portion 190a differs from lower portion 190 of separator 110. In this embodiment, lower portion 190 includes body portion 280 defining first wire-insulation-receiving channel portion 208a and second wire-insulation-receiving channel portion 210a and base portion 282.

Body portion 280 is connected to, or integral with upper portion 192, and also defines first socket-receiving channel 284a and second socket-receiving channel 284b, each for receiving a portion of lamp socket 112a, as described further below. Each channel 284 extends circumferentially about base portion 280 and may be arcuate as depicted. In an embodiment, lamp socket 112a fits into channels 284 to form a snap fit, or other similar mechanical fitment.

Base portion 282 is connected to, or integral with body portion 280 and as depicted in this embodiment, forms a plate-like structure. Base portion 282 may be generally circular as depicted, with or without flat edges. Base portion includes upper surface 285 and defines a pair of wire-receiving holes 286, first wire receiving hole 286a and second wire-receiving hole 286b. Wire-receiving holes 286 are configured to each accept and position a respective wire 104.

When assembled, wire 104a is inserted through wire-receiving hole 286a and insulated portion 172a of wire 104a is received into first channel 208a; wire 104b is inserted through wire-receiving hole 286b and insulated portion 172b of wire 104b is received into second channel 208b. Upper portion 192 is fit between respective insulated portions 172 and uninsulated and coated portions 174, and upper portion 194 abuts lens 120 . . . . This subassembly is referred to as subassembly 113 for the sake of explanation.

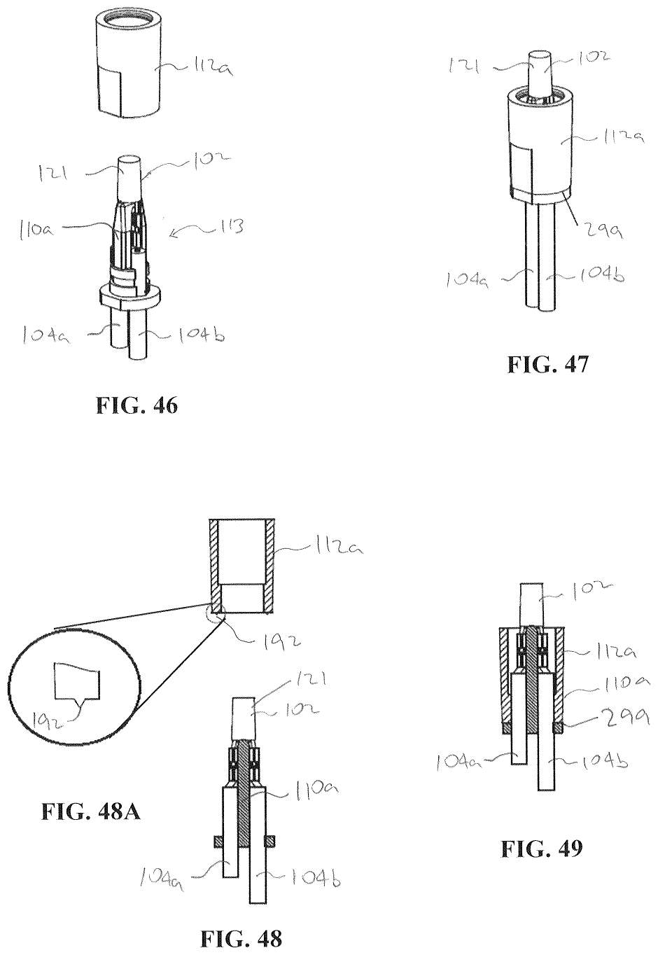

Referring now to FIGS. 46-49, subassembly 113 and an embodiment of lamp socket 112a are depicted. Similar to the embodiment described above with respect to FIGS. 1-34, lamp socket 112a receives subassembly 113 such that lamp socket 112a is securely attached to separator 110a of subassembly 113 so as to prevent or minimize moisture infiltration into lamp socket 112a.

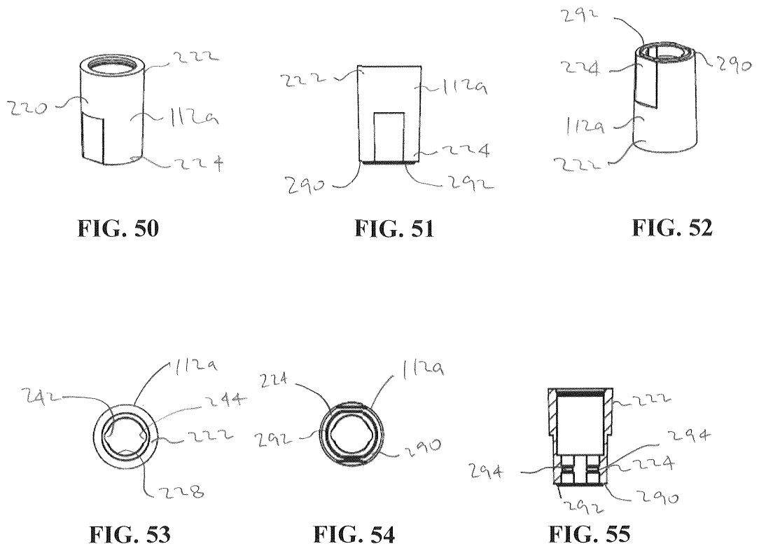

Referring also to FIGS. 50-55, an embodiment of lamp socket 112a is depicted. Lamp socket 112a is substantially the same as lamp socket 112 with some exceptions, including that lamp socket 112a includes different structure for connecting to separator 110a. Consequently, the description below will focus on the differences, with the understanding that other features and structures are similar or the same as described above with respect to lamp socket 112.

In an embodiment, lamp socket 112a includes main or body portion 220, first or top end 222, second or lower end 224, and inside surface 228. Lower end 224 includes a lower edge with lower surface 290. Projecting portion or ridge 292 projects axially from lower surface 290 and is configured to abut and be connected to base 282 of separator 110a (see also, FIG. 40). In an embodiment, ridge 292 forms an annular ring extending circumferentially about lower surface 290 and projecting axially downward.

An inner portion of lower portion 224 of lamp socket 112a defines wire-receiving grooves 242 in inner surface 228 for receiving insulated portions 172 of wires 104, similar to lamp socket 112. Lower portion 224 at inner surface 228 also includes one or more ridges 294 configured to fit into first and second socket-receiving channels 284a, 284b of separator 110a (see also FIGS. 40-43 for depictions of separator 110a).

When lamp socket 112a is assembled to subassembly 113, including separator 110a, ridges 294 are receiving into first and second socket-receiving channels 284a, 284b of separator 110a, which in an embodiment comprises a snap fit. Ridge 292 is adjacent to top surface 285 of lamp separator 110a. In an embodiment, ridge 292 may fit into a groove or channel in top surface 285 (not shown). In another embodiment, ridge 292 may be used to ultrasonically weld lamp socket 112a to surface 285 of separator 110a, thereby forming a secure, watertight fitment between lamp socket 112a and separator 110a at a weld region 299. In such an embodiment, ridge 192 deforms and may melt onto surface 285 to form a plastic weld joint. In an embodiment, separator 110a and lamp socket 112a comprise the same material, which may be a polymer material, such as polypropylene, polyethylene, polyvinyl chloride and others.

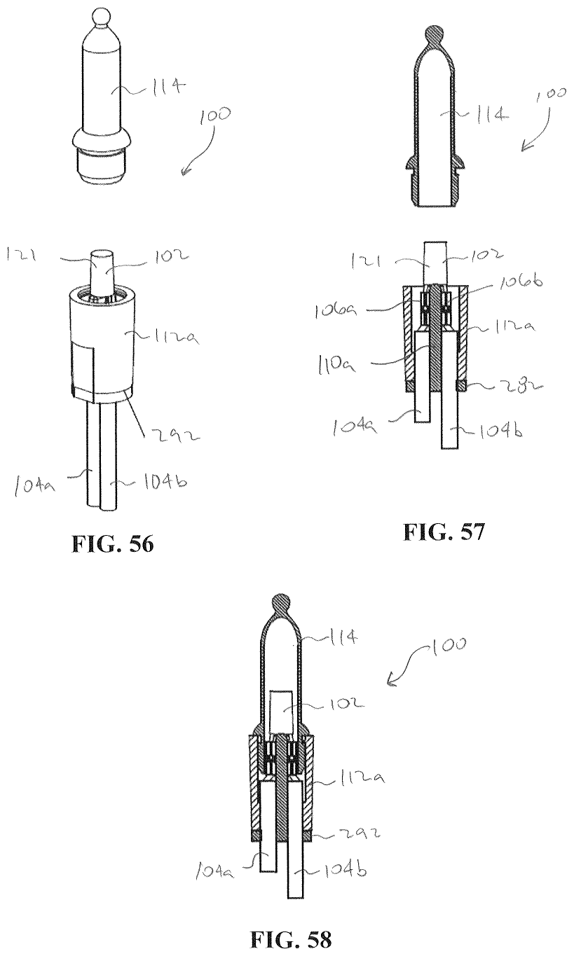

Referring also to FIGS. 56-58, assembled LED lamp assembly 100 comprising separator 110a and lamp socket 112a is depicted (though depicted without conformal coating 108 for the sake of illustration). Similar to the embodiment of FIGS. 1-34, LED lamp assembly 100 in this embodiment includes cap or cover 114 that is coupled to lamp socket 112a in the same manner as described above.

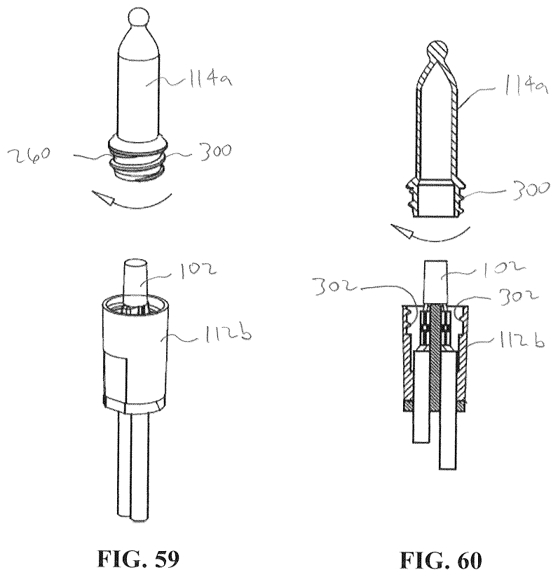

Referring to FIGS. 59-60, a variation of the lamp assembly 100 of FIGS. 35-58 is depicted. The embodiment of LED lamp assembly 100 as depicted in FIGS. 59-72 includes a threaded cover or cap 114a and a threaded lamp socket 114b, but is otherwise substantially the same as the embodiment of FIGS. 35-58.

In this embodiment, lower portion 260 of cover 114a includes external screw thread 300 which mates with internal screw thread 302 of socket 114b. As such, threaded cover 114a may be inserted into threaded lamp socket 112b by engaging threads 300 with threads 302 and rotating threaded cover 114a causing it to couple with threaded lamp socket 112b.

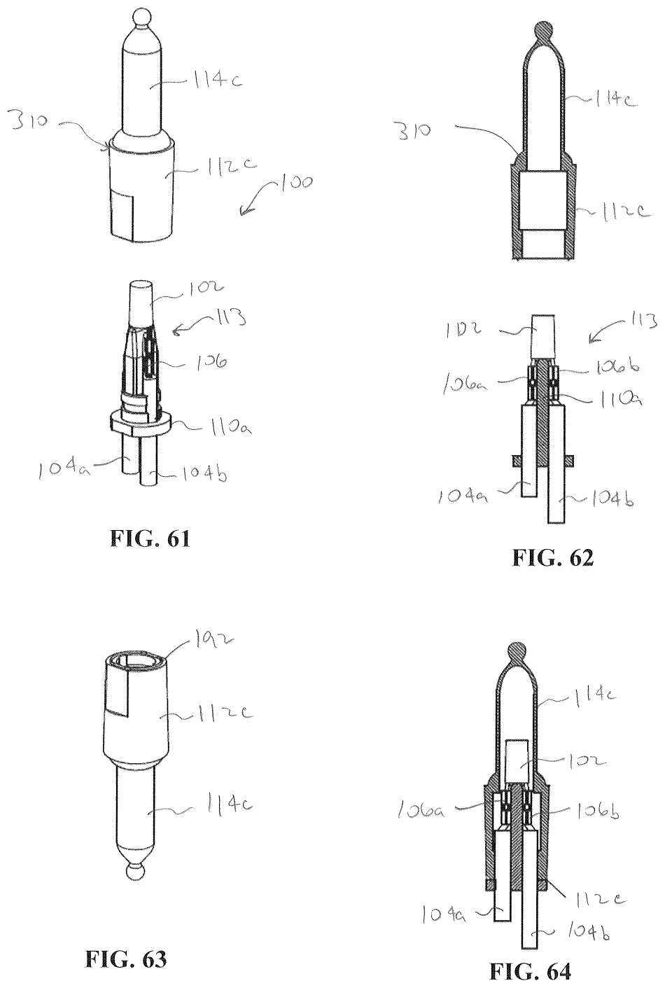

Referring to FIGS. 61-64 another embodiment of LED lamp assembly 100 is depicted. This embodiment of LED lamp assembly 100 is substantially similar to the embodiment described with respect to FIGS. 35-49 with at least some differences that relate to lamp socket 112 and cover 114.

In this embodiment, LED lamp assembly 100 includes subassembly 113 with lamp 102, separator 110a, electrical connectors 106, conformal coating 108 (see previous figures), and wires 104. LED lamp assembly 100, in this embodiment, also includes integrated cover-socket 310, which includes cover portion 114c and socket portion 112c. In an embodiment, socket portion 112c and cover portion 114c may comprise a common material, such as polycarbonate, polyvinyl chloride, polypropylene, and so on. In such an embodiment cover-socket 310 may be manufactured in a single molding process. In other embodiments, socket portion 112c and cover portion 114c may be integrated to form cover-socket 310, but may comprise differing materials. In one such embodiment, cover portion 114c may comprise a transparent of semi-transparent material, such as polycarbonate, and socket portion 112, may comprise a different material, such as polypropylene or another polymer. In an embodiment, cover 114c comprises a first material, such as polycarbonate or glass, and socket portion 112c comprises a polymer material, such as polypropylene, and is molded or overmolded onto cover 114c to form the integral cover-socket 310.

In an embodiment, and as depicted, socket portion 112c may include ridge 192 that is ultrasonically welded to separator 110a, as described above.

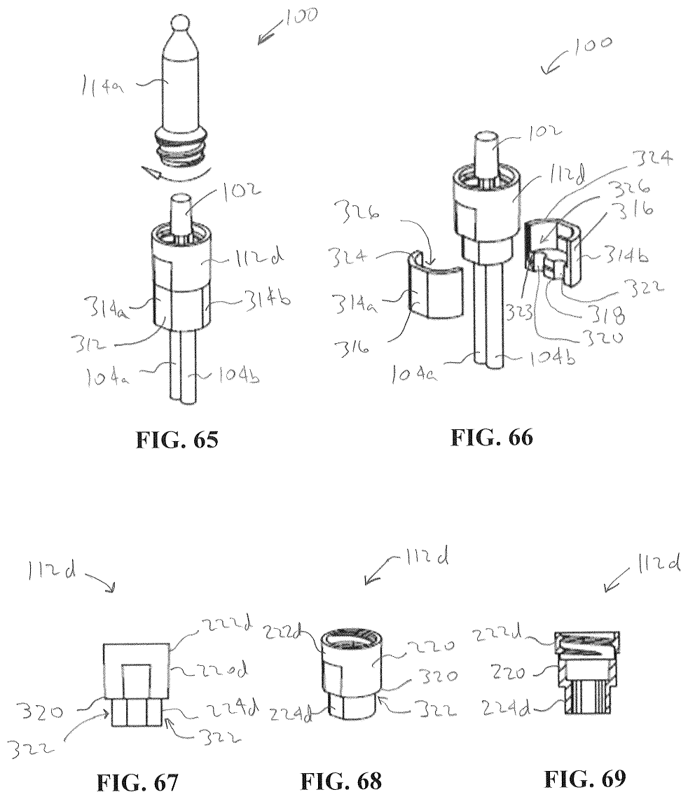

Referring to FIGS. 65-69, another embodiment of LED lamp assembly 100 is depicted. In this embodiment, LED lamp assembly 100 includes threaded cover 114a (also described above), with threaded lamp socket 112d that is similar to lamp socket 112, but with a threaded upper portion to receive threaded cover 114a, also similar to lamp socket 112b. Notably, in this embodiment, LED lamp assembly 100 also includes wire stabilizer and socket sealer (stabilizer-sealer) 312, which includes first or left wire-stabilizer-socket-sealer portion 314a and second or right wire-stabilizer-socket-sealer portion 314a.

Referring specifically to FIGS. 67-69, in this embodiment, lamp socket 112d includes main or body portion 220d with upper portion 222d and lower portion 224d. In an embodiment, and as depicted, lower portion 224d has a smaller outside diameter and circumference as compared to an outside diameter and circumference of upper portion 222d. This difference in size creates step or corner 320 in body portion 220, as well as causing body portion 220 to define circumferential gap 322 around lower portion 224d and below upper portion 222d.

Referring to FIG. 66, stabilizer-sealer 312 with first stabilizer-sealer portion 314a and second stabilizer-sealer separated from lamp socket 112d for the purposes of illustration. In an embodiment, and as depicted, first stabilizer-sealer portion 314a is substantially the same as second stabilizer-sealer portion 314b, one configured to connect to the other. In an embodiment, each stabilizer-sealer portion 314a, 314b includes an outer wall 316, bottom wall 318 defining first wire-receiving channel 320 and second wire-receiving channel 322, vertical wall 323, top edge 324 and defines socket-receiving cavity 326.

Referring also to FIG. 65, when assembled or connected to lamp socket 112d, wires 104 are received into receiving channels 318 and 322 of each of stabilizer-sealer 314a, 314b, lower portion 324d of lamp socket 112d is received into cavities 326, upper edges 324 of stabilizer-sealer portions 314a, 314b abut upper portion 322 and step 320, circumferential gap 322 is filled by portions of stabilizer-sealers 314a, 314b, and vertical wall 323 of stabilizer-sealer 314a abuts vertical wall 323 of stabilizer 314b. As briefly described above, stabilizer-sealers 314 may be configured to connect to one another, such as by a snap fit, friction fit, or other joining of structural elements. In some embodiments, stabilizer-sealers 314 may be ultrasonically welded or glued together.

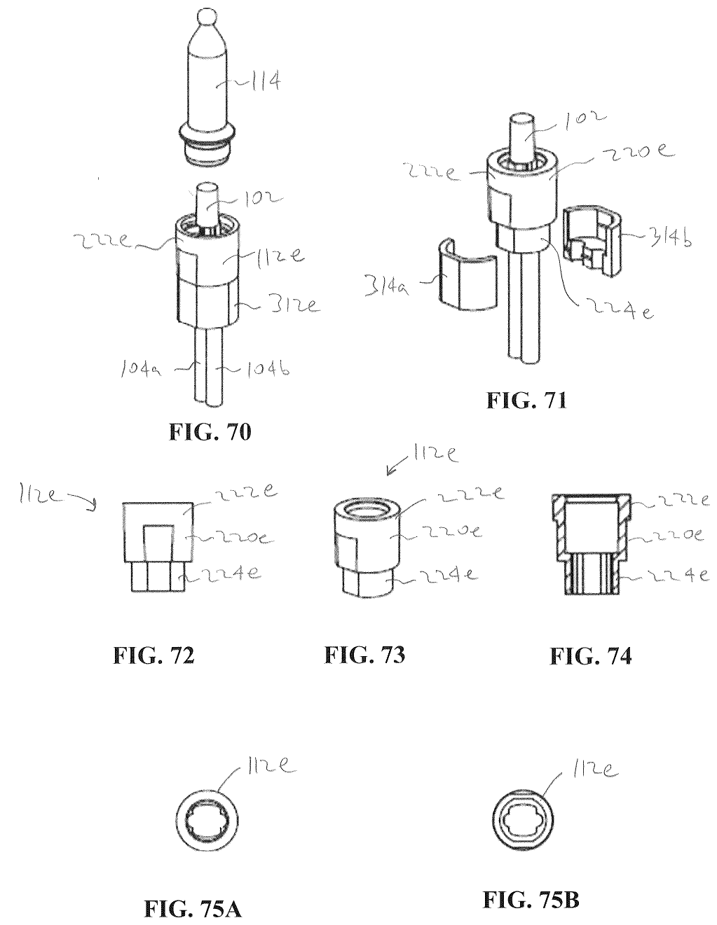

Referring to FIGS. 70-75B, in which FIG. 75A is a bottom view and FIG. 75B is a top view, another embodiment of LED lamp assembly 100 is depicted. The embodiment of LED lamp assembly 100 depicted in FIGS. 70-75B is substantially the same as the embodiment depicted with respect to FIGS. 65-69, with at least the exception that unlike cover 114am cover 114 is not threaded, and lamp socket 112e is also not threaded. Lamp socket 112e is substantially the same as lamp socket 112d, with the exception that lamp socket 112e does not have internal threads like lamp socket 112d, and is configured to receive cover 114 in substantially the same manner as lamp socket 112 receives cover 114.

Consequently, in this embodiment, LED lamp assembly 100 includes lamp assembly includes LED lamp 102, separator 110 (see FIGS. 15-19), lamp socket 112e, wires 104a and 104b, electrical connectors 106a and 106b (see FIGS. 8-11), conformal coating 108 and stabilizer-sealer 312 with portions 314a and 314b Lamp socket 112e includes main or body portion 220e, upper portion 222e and lower portion 224e.

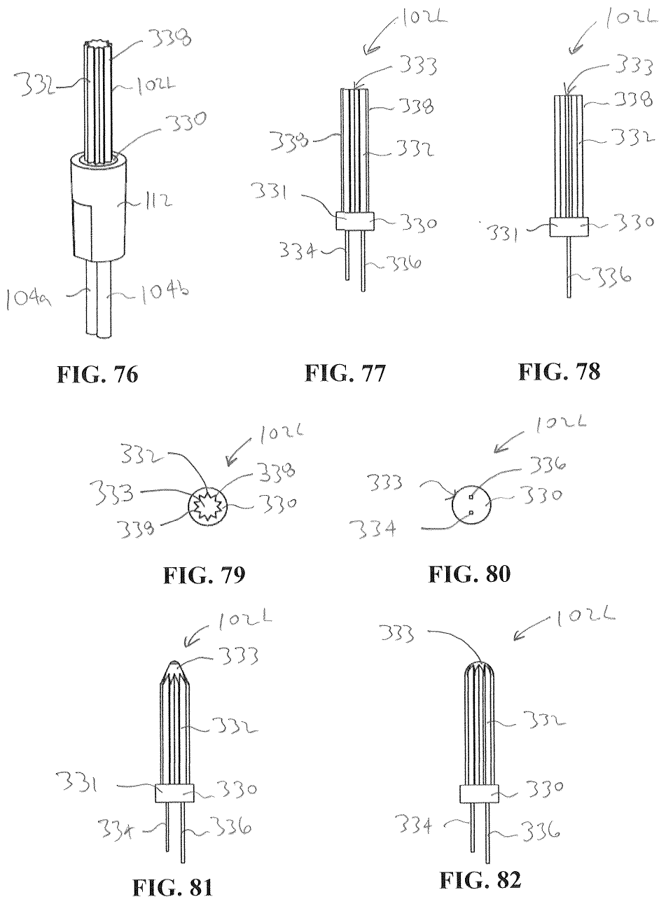

Referring to FIGS. 76-96, another embodiment of an LED lamp 102 and corresponding LED lamp assembly 100 is depicted. In this embodiment, and as will be described in further detail below, LED lamp 102 may include multiple LED elements 126 distributed vertically within the lamp, and hereinafter will be referenced as LED lamp 102L for a “long” LED lamp.

Referring to FIGS. 76 assembled LED lamp assembly 100 is similar to the LED lamp assemblies 100 described above, and includes lamp 102L and wires 104a and 104b inserted into socket 112.

Referring to FIGS. 77-80, and embodiment of LED lamp 102L is depicted. FIG. 77 is a front view of LED lamp 102L, FIG. 78 is a right-side view of LED lamp 102L, FIG. 79 is a top view of LED lamp 102L and FIG. 80 is a bottom view of LED lamp 102L. In an embodiment, LED lamp 102L includes lower or base portion 330 with circumferential side surface 331, upper portion 332 with top surface 333, first polarity lead frame 334 and second polarity lead frame 336. Additional details of lead frames 334 and 336, as well as other LED lamp 102L details are described below.

In an embodiment, lower and upper portions 330 and 332 comprise a transparent or semi-transparent material, such as polycarbonate. In an embodiment, rather than comprising a cover or cap, upper and/or lower portions 330 and 332 are formed or molded directly onto lead frames 334 and 336, such that lower and upper body portions essentially form a lens, similar to lens 120 over upper portions of lead frames 334 and 336 and the interior LED elements 126 (described and depicted below).

In the embodiment depicted, lower portion 330 forms an annular disk, though other shapes are contemplated that conform to an opening in socket 112 so as to be fitted into socket 112.

In the embodiment depicted, upper portion 332 is generally cylindrical, and extends upwardly and away from lower portion 330. As depicted, upper portion 332 may include a plurality of vertically extending ribs 338 distributed about the circumference of upper portion 332, and may form a “star” pattern when viewed from above. Such ribs transmit and disperse light emitted from LED elements 126 within upper portion 332. In one embodiment, surface 333 of upper portion 332 is flat.

Referring to FIGS. 81 and 82, alternate embodiments of LED bulb 102L are depicted. The two respective depicted embodiments are substantially the same as the LED bulb 102 of FIGS. 76-80, with the exception of top surfaces 333 of upper portions 332. In the embodiment of FIG. 81, top surface 333 is conical with a rounded tip, while in the embodiment of FIG. 82, surface 333 is dome shaped. Both embodiments provide unique lighting effects based on how light is transmitted out of the top of LED bulb 102L.

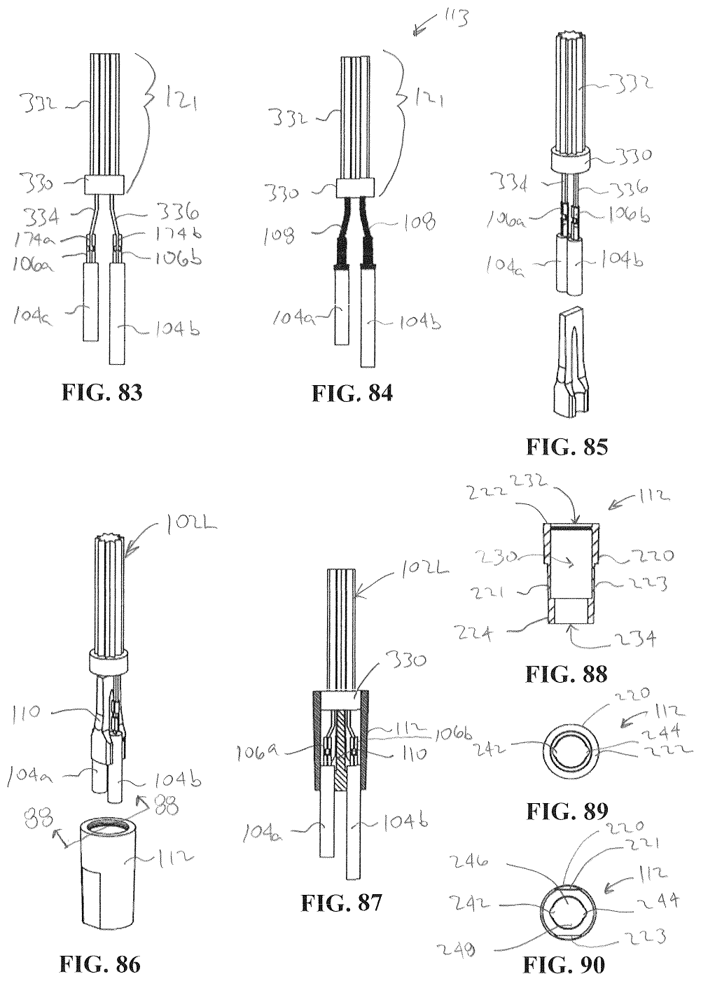

Referring to FIGS. 83-87, LED lamp 102L assembled to wires 104, with separator 110 and socket 112 are depicted in various stages of assembly. Similar to LED lamp assembly 102 as described above, LED lamp assembly 102L includes an upper LED lamp assembly 121, and a subassembly 113 that includes LED lamp 102L, wires 104a, 104b, conductor-lead-frame connectors 106a, 106b, conformal coating 108 and separator or isolator device 110, as described further below.

Referring specifically to FIG. 83, substantially similar to the embodiments described above, first polarity lead frame 330 is connected to first uninsulated portion 174a of wire 104a via electrical connector 106a and second uninsulated portion 174b of wire 104b via electrical connector 106b. In the embodiment depicted, each of lead frames 334 and 336 are bent outwardly, though in other embodiments, lead frames 334 and 336 are not bent, and remain straight as depicted in FIGS. 77-78. Placing a bend in lead frames 334 and 336 may facilitate fitment of separator 110, in some embodiments.

Referring to FIG. 84, conformal coating 108 as been added to lead frames 334, 336, electrical connectors 106 and uninsulated portions 174a, 174b, and in some embodiments, to top portions of insulated portions 172.

Referring to FIGS. 85-86, separator 110 is positioned to be inserted between wires 104 (FIG. 85), then with separator 110 in place and ready for coupling with socket 112. Conformal coating 108 is not depicted for the sake of illustration, though in embodiments it will be present as described above. Referring also to FIG. 87, a cross-sectional view of assembled LED lamp assembly 102L is depicted.

Referring also to FIGS. 88-90, an embodiment of socket 112 is depicted. FIG. 88 is a sectional view down the middle of socket 112; FIG. 89 is a top view of socket 112; and FIG. 90 is a bottom view of socket 112. This embodiment of socket 112 is substantially the same as those depicted above, and includes main or body portion 220 with opposing flattened surfaces 221 and 223, top end 222, lower end 224. Body portion 220 also defines receiving cavity 230, top opening 232 and bottom opening 234. Body portion 220 also defines wire-receiving channels 242, 244 and a pair of opposing lower-separator-receiving portions 246 and 248, as also described above with respect to the other embodiments of socket 112.

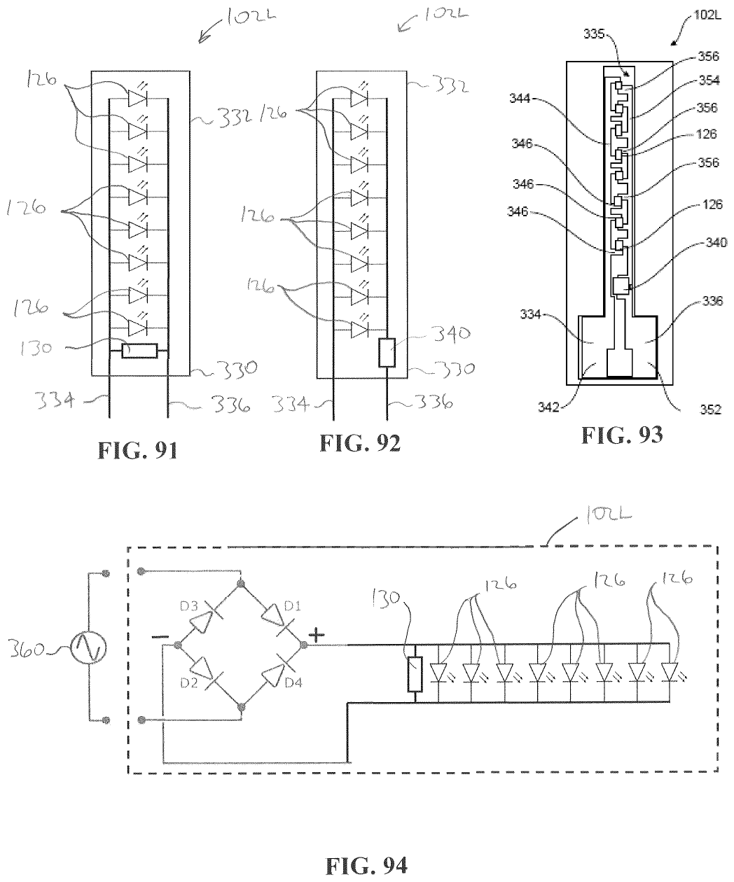

Referring to FIGS. 91-95, a number of embodiments of circuits of LED bulb assembly 102L are depicted.

Referring specifically to FIG. 91, a schematic diagram of a circuit of LED lamp 102L having a plurality of LED elements 126 electrically connected in parallel between first polarity lead frame 334 and second polarity lead frame 336. The number of LED elements 126 per LED lamp bulb 102 may vary depending on desired brightness, light concentration, bulb size, and so on. In an embodiment, each LED lamp bulb includes 2 to 10 LED elements 126. In another embodiment, each LED lamp bulb includes 4 to 8 LED lamp elements. Having 4 to 8 LED elements 126 may provide a sufficiently bright and cost effective bulb. In one such embodiment, LED bulb 102 includes 8 LED elements 126 as depicted.

In the depicted embodiment, LED bulb 102L also includes optional bypass element 130 electrically connected in parallel with LED elements 126 (see above for additional description of bypass element 130).

Referring also to FIG. 92, a schematic diagram of another embodiment of LED bulb 102L is depicted. This embodiment is substantially similar to the embodiment of LED bulb 102L having a plurality of LED elements 126 electrically connected in parallel as depicted and described with respect to FIG. 91, with the exception of an electrical element 340, such as a load resistor, that is added in electrical series with the LED elements 126. Bypass element 130 may or may not be present. Electrical element 130 may be used to create an additional voltage drop across LED bulb 102, depending on the circuit that LED bulb 102 is in.

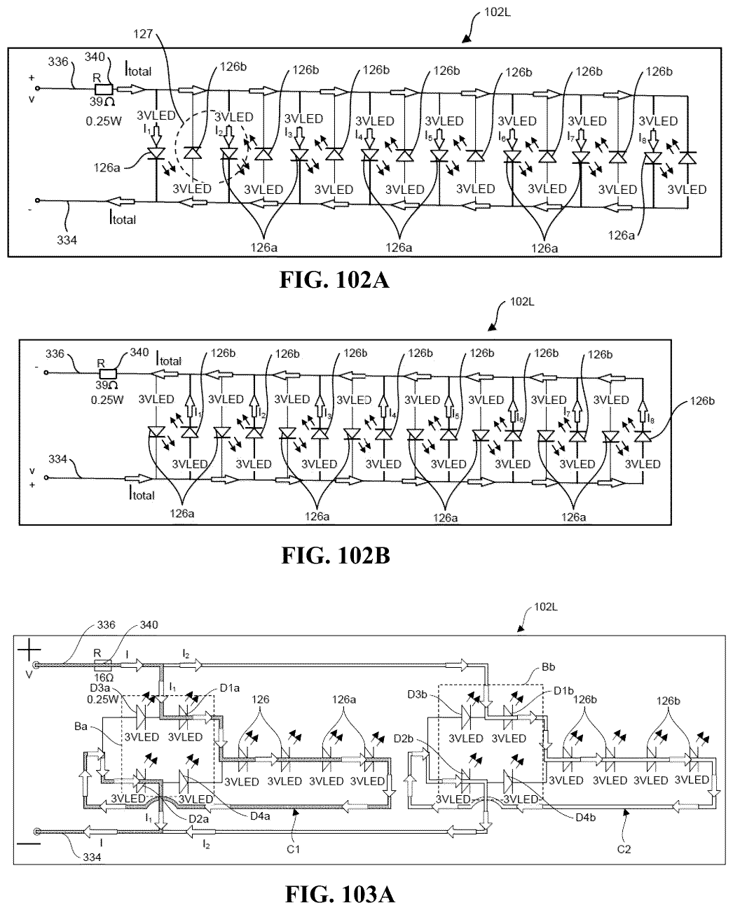

Although all LEDs 126 in FIGS. 91 and 92 are depicted as being oriented to have the same polarity, such as would typically be used when applying DC power, in an embodiment, the polarity of LEDs 126 may alternate polarity for AC applications. Such embodiments re described below with respect to FIGS. 102A and 102B.

FIG. 93 is a schematic diagram depicting a physical layout of the LED lead frames 334 and 336, and has the same electrical circuit as FIG. 92. In an embodiment, each of first polarity lead frame 334 and second polarity lead frame 336 is generally flat and planar. Leads frames 334 and 336 may be support by, and be mounted to, an underlying substrate, such as the substrate used for printed circuit boards and comprising epoxy resin, dielectric material and glass fiber. In an embodiment, the printed circuit board material may be transparent or translucent such that light emitted from LEDs 126 may pass through the printed circuit board. In an embodiment, “lead frames” may actually be conductive layers printed on the substrate 335, and may comprise a substrate-based conductor platform or conductor system, rather than traditional lead frames formed from stamped metal, i.e., may not comprise a “frame” at all. See also, FIG. 96, described further below, that depicts a portion of LED lamp 102L with substrate 335.

Lamp assemblies 102 comprising the LED lead frames 334 and 336 mounted on a substrate or printed circuit board may be inserted into a cover 114, as described above, while the substrate supports LEDs 126 and positions them into the interior of the cover, displaced from the lamp socket.

In an embodiment, first-polarity lead frame 334 includes base portion 342, vertical run or arm-connection portion 344 and a plurality of arms 346 extending transversely from vertical run 344. An end of each arm 346 is electrically connected to an LED element 126, such as to an anode portion. In an embodiment, base portion 342, vertical run 344 and arms 346 form a contiguous conductive portion.

Similarly, second-polarity lead frame 336 includes base portion 352, vertical run or arm-connection portion 354 and a plurality of arms 356 extending transversely from vertical run 354. An end of each arm 356 is electrically connected to an LED element 126, such as to a cathode portion. In an embodiment, base portion 352, vertical run 354 and arms 356 form a contiguous conductive portion. However, when optional electrical element 340 is present, vertical run 354 may include a break or discontinuity in order to electrically connect element 340 to LED elements 126 in series.

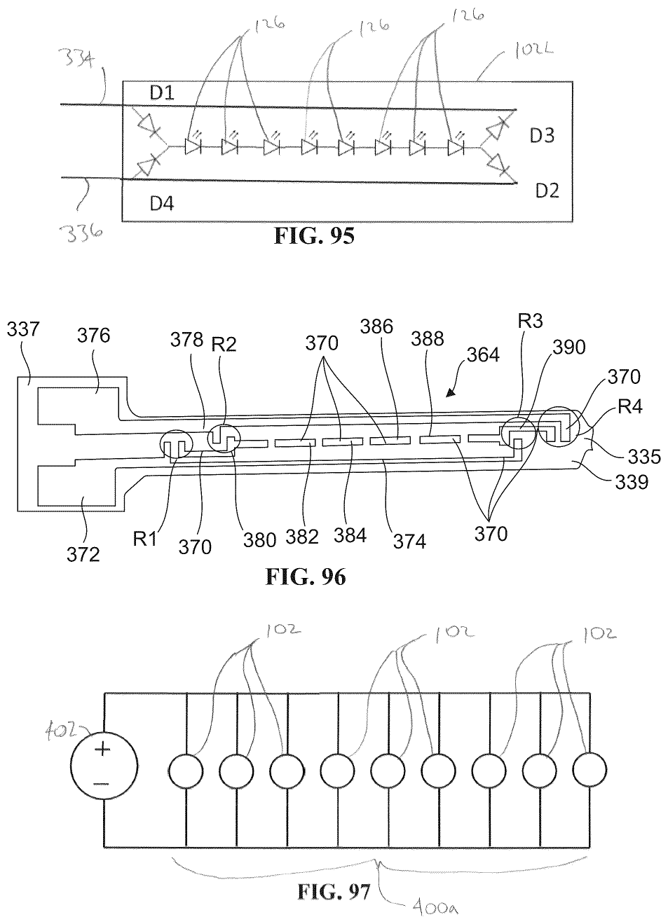

Referring to FIG. 94, in an embodiment, LED bulb 102L (and corresponding LED lamp assembly 100) may be configured to be electrically connected to an alternating-current (AC) power source, such as AC power source 360, and may include a full-bridge rectifier that 362 that includes rectifying diodes D1, D2, D3 and D4. In this embodiment, LED lamp 102L is configured the same as the embodiment of FIG. 91, with parallel LED elements 126 and bypass element 130. In this embodiment, multiple lamps 102L may be electrically connected in series and powered by an AC power source, though other configurations are possible. In an embodiment, and as depicted, rectifying diodes D1 to D4 may be integrated into LED bulb 102, with or without bypass element 130 and/or element 340, with LED elements 126 in various electrical configurations, including as depicted in FIG. 94 and also as depicted in FIG. 95.

Referring also to FIG. 95, LED lamp 102L includes multiple LED elements 126 electrically connected in series, and connected to a full-wave rectifying bridge that includes diodes D1, D2, D3 and D4. The number of LED elements 126 may vary depending on desired lamp brightness, size, and particularly, lamp voltage. In an embodiment, each LED element 126 has a voltage drop of approximately 3V. In the embodiment depicted, with 8 LED lamp elements 126, LED lamp 102L would have a voltage drop of approximately 24V. Five such LED lamps 102L of this embodiment could be electrically connected in series and connected to a 120 VAC power source, such as AC power source 360, without the need to provide a separate and relatively large rectifier to convert to direct-current (DC) power. Other quantities of series-connected LED lamps 102L are contemplated, not just the 8 elements 126 as depicted in FIG. 95.

Referring also to FIG. 96, a PCB-substrate-based conductor platform 364 for use with the series-connected LED bulb 102L of FIG. 95 is depicted. In this embodiment, conductor platform 364 includes substrate 335 and a plurality of conductive portions or traces 370. In an embodiment, each conductive portion 370 may be a conductive trace printed onto substrate 335. Substrate 335 may be generally flat and planar, and may form various shapes, including a rectangular shape.

In an embodiment, the plurality of conductive portions 370 interconnect the LED elements 126 and rectifying diodes D1 to D4. In one such embodiment, the plurality of conductive portions 370 include first polarity conductive base portion 372, first-polarity conductive extension portion 374, second-polarity conductive base portion 376 and second polarity extension portion 378. The plurality of conductive portions 370 also includes conductive portions 380, 382, 384, 386, 388 and 390. First polarity conductive base portion 372, in an embodiment and as depicted, forms a rectangular portion and connects to conductive portion 374 which extends along an outside edge of substrate 335 from first end 337 to second end 339 of substrate 335. Second polarity conductive base portion 376, in an embodiment and as depicted, forms a rectangular portion and connects to conductive portion 378 which extends along an outside edge of substrate 335 from first end 337 to second end 339 of substrate 335. The remaining sections generally extend along a central axis between extension portions 374 and 378.

Referring also to FIG. 95, LED elements 126 and diodes D1 to D4 may be surface mounted or otherwise mounted to substrate 335 and to conductive portions 370. In an embodiment, diode D4 is connected between conductive portion 374 and portion 380 at region R1; diode D1 is connected between conductive portion 378 and portion 380 at region R2; diode D2 is connected between portion 380 and portion 390 at region R3; and diode D3 is connected between portion 378 and portion 390 at region R4. LED elements are connected respectively between pairs of portions 380 and 382, 382 and 384, 384 and 386, 386 and 388 and 388 and 390, such that the LED elements 126 are electrically connected in series. The polarity of the diodes D1 to D4 and LED elements 126 are as depicted in FIG. 9, with “lead frame” 334 corresponding to portion 376 and lead frame 336 corresponding to portion 372.

In an embodiment of multi-diode LED lamp 102L that includes PCB-substrate-based conductor platform 364, the substrate, printed circuits or lead frames 334, 336, LEDs 126 and other electrical components may be fully or partially covered with a coating or sealing material, such as an epoxy, adhesive, resin, and so on, which may be the same as, or similar to, conformal coating 108. In an embodiment, the substate and electrical components are covered or coated in a sealing and reflective material, such as a fluorescent covering, such as a layer of phosphor material, in an embodiment, that causes light emitted from LEDs 126 to be reflected, refracted and/or diffused, producing a more uniform transmission of light from LED lamp 102.

Multi-diode LED lamp 102L comprising PCB 364 may also include a controller, such as an IC controller chip, as mentioned above. The controller may be mounted on PCB 364 in a manner similar to LEDs 126, and be in electrical connection and communication with LEDs 126 via the electrical traces. The controller may be configured to selectively control operation of one or more LEDs 126.

Referring to FIGS. 97-99, several electrical schematic diagrams of circuits of decorative light strings 400 that include a plurality of LED bulbs 102 and LED lamp assemblies 100 are depicted. For the sake of explanation, when describing circuit diagrams, reference will be made to LED bulbs 102 as the electrical components, though it will be understood that each LED bulb 102 is part of a corresponding LED lamp assembly 100.

Referring specifically to FIG. 97, an electrical schematic of a parallel-connected embodiment of decorative light string 400a is depicted. In this embodiment, a plurality of LED bulbs 102 are connected in parallel. Light string 400a is configured to be connected to a DC power source. LED bulbs 102 may include any of the LED bulbs 102 described herein, including any of LED bulbs 102L.

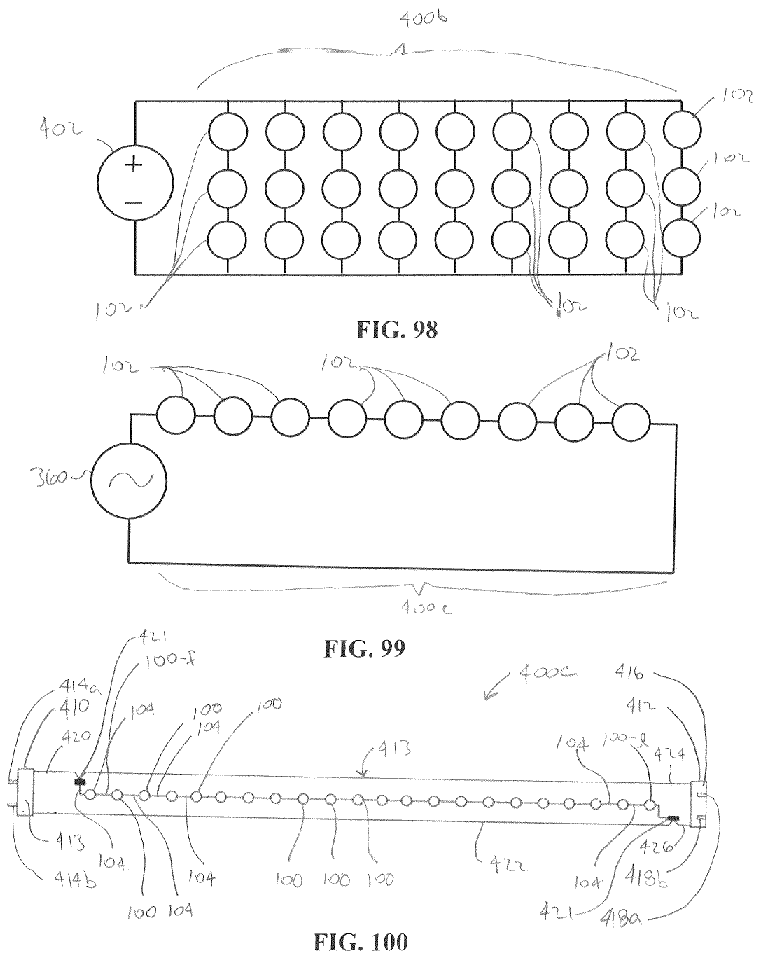

Referring specifically to FIG. 98, an electrical schematic of a parallel-series-connected embodiment of light string 400b is depicted. In this embodiment, groups of 3 LED bulbs 102 are connected in series, and each group is connected in parallel. In this embodiment, each group of LED bulbs 102 is depicted as having 3 bulbs 102, but it will be understood that more or fewer bulbs may be used, depending on desired voltage drop across each group. Further, 9 groups of LED bulbs 102 are depicted, but it will be understood that more or fewer groups of LED bulbs may be used for each light string 400b. Light string 400b is configured to be connected to a DC power source or an AC power source, depending on the type of LED bulb 102 used. LED bulbs 102 may include any of the LED bulbs 102 described herein, including any of LED bulbs 102L.

Referring to FIG. 99, an electrical schematic of a series-connected embodiment of decorative light string 400c is depicted. In this embodiment, a plurality of LED bulbs 102 are electrically connected in series. Although 9 LED bulbs 102 are depicted in series, fewer or more LED bulbs 102 may be used, depending on the voltage of the individual LED bulbs 102 and the power source 360. In this embodiment, light string 400c may be configured to connect to an AC power source 360. LED bulbs 102 may include any of the LED bulbs 102 described herein, including any of LED bulbs 102L.

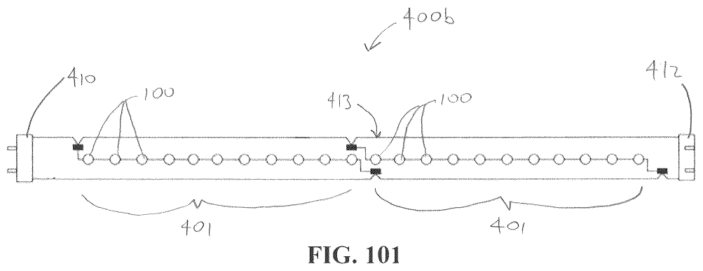

FIGS. 100 and 101 depict schematic diagrams of a series-connected decorative light string 400c and an embodiment of a series-parallel light string 400b, respectively.

Referring specifically to FIG. 100, in this embodiment, decorative light string 400c includes power plug 410, power end connector 412, wire set 413 and a plurality of LED lamp assemblies 100 with LED bulbs 102. In an embodiment, light string 400c may not include power end connector 412.

Power plug 410, in an embodiment, comprises a plug housing 413. and a pair of electrical terminals 414a and 414b. Power end connector 412 includes housing 416, a pair of electrical terminals (not depicted) inside housing 416 and defines a pair of terminal-receiving channels 418a and 418b. Terminal-receiving channel 418a is configured to receive an electrical terminal 414a from a power plug 410 of another light string 400c, and terminal-receiving channel 418b is configured to receive an electrical terminal 414b from the power plug 410 of another light string 400c.

Wire set 413 includes a plurality of lamp-connecting wires 104 that connect the plurality of lamp assemblies 100 in series to one another, lead wire 420 connecting electrical terminal 414a of power plug 410 to a first LED lamp assembly 100-f, which may be via a three-wire connector 421, return wire 422 which electrically connects electrical terminal 414b of power plug 410 to the last lamp assembly in the series, LED lamp assembly 100-1. When power end connector 412 is present as depicted, wire set 413 includes first end-connect wire 424 which electrically connects first electrical terminal 414a of power plug 410 to a first electrical terminal of power end connector 412, and second end-connect wire 426 which electrically connects second electrical terminal 414b of power plug 410 to a second electrical terminal of power end connector 412. In this manner, when power plug 410 is connected to a power source, power end connector 412 is also connected to the power source.

The plurality of LED lamp assemblies 100 comprises any of the LED lamp assemblies 100 described herein, including any embodiments of the LED bulbs 102, including LED bulbs 102L. In the depicted embodiment, for the sake of illustration, 22 LED lamp assemblies are depicted, though it will be understood that more or fewer LED lamp assemblies 100 may be included, depending on many factors, including voltage of an expected power source, desired brightness, properties, including operating voltages of LED bulbs 102, and so on.

Referring to FIG. 101, an embodiment of series-parallel decorative light string 400b is depicted. In this embodiment, light string 400b is similar to light string 400c, though instead of one group of series connected LED lamp assemblies 100, light string 400b includes two or more groups 401 of series-conned LED lamp assemblies 100, each connected to the other in parallel. Similar to light string 400c, light string 400b includes power plug 410, power end connect 412, wire set 413 and a plurality of LED lamp assemblies 100. The plurality of LED lamp assemblies 100 comprises any of the LED lamp assemblies 100 described herein, including any embodiments of the LED bulbs 102, including LED bulbs 102L. In the depicted embodiment, for the sake of illustration, 22 LED lamp assemblies total are depicted, with 11 LED lamp assemblies in each group 401. However, it will be understood that more or fewer LED lamp assemblies 100 may be included, depending on many factors, including voltage of an expected power source, desired brightness, properties, including operating voltages of LED bulbs 102, whether the LED lamps 102 include one or multiple LED elements 126, including whether the multiple LED elements 126 are connected in series of parallel, and so on.

Consequently, when embodiments of light strings 400 include LED bulbs 102L, each bulb 102L including multiple LED elements 126, a variety of circuit configurations for each light string 400 is possible. Such configurations include, but are not limited to: a simple series-connected light string 400 with one group of LED lamp assemblies 100, each lamp assembly 100 and LED bulb 102 of the one group electrically connected to the other in series, each LED bulb 102 including a single LED element 126; a series-parallel-connected light string 400 with two or more groups of LED lamp assemblies 100, each lamp assembly 100 and LED bulb 102 of each group electrically connected to the other in series, each LED bulb 102 including a single LED element 126, each group of LED lamp assemblies 100 connected to the other in parallel; a parallel-connected light string 400 with a plurality of LED lamp assemblies 100, each lamp assembly 100 and LED bulb 102 electrically connected to the other in parallel, each LED bulb 102 including a single LED element 126; a parallel-series-connected light string 400 with two or more groups of LED lamp assemblies 100, each lamp assembly 100 and LED bulb 102 of each group electrically connected to the other in parallel, each LED bulb 102 including a single LED element 126, each group of LED lamp assemblies 100 connected to the other in series; another series-connected light string 400 with one group of LED lamp assemblies 100, each lamp assembly 100 having an LED bulb 102L, each lamp assembly 100 of the one group electrically connected to the other in series, each LED bulb 102L including multiple LED element 126, with the LED elements 126 electrically connected in parallel or series to each other; a series-parallel-connected light string 400 with two or more groups of LED lamp assemblies 100, each lamp assembly 100 including a LED bulb 102L, each LED bulb 102L of each group electrically connected to the other in series, each LED bulb 102L including multiple LED elements 126, with the LED elements 126 electrically connected in parallel or series to each other, and each group of LED lamp assemblies 100 connected to the other in parallel; a parallel-connected light string 400 with a plurality of LED lamp assemblies 100 with LED lamps 102L, each lamp assembly 100 and LED bulb 102 electrically connected to the other in parallel, each LED bulb 102 including a multiple LED elements 126, with the LED elements 126 electrically connected in parallel or series to each other; a parallel-series-connected light string 400 with two or more groups of LED lamp assemblies 100, each lamp assembly 100 including an LED bulb 102L, each LED bulb 102L of each group electrically connected to the other in parallel, each LED bulb 102 including multiple LED elements 126, each group of LED lamp assemblies 100 connected to the other in series. Further variations of the embodiments of light strings 400 listed above may include LED lamp assemblies 100 that include both single-LED-element bulbs 102 and multiple-LED-element bulbs 102L in the same light string and/or same group of LED lamp assemblies.

In some embodiments, LED lamp assemblies 100 may each include a control device for controlling an LED bulb 102 associated with said control device. Such a control device, not depicted, may comprise an integrated-circuit chip with a processor for controlling one or more LED elements 126 of LED bulb 102. In one such embodiment, the control device is located within LED bulb 102; in another embodiment, the control device is located outside LED bulb 102, but within LED lamp assembly 100, e.g., within lamp socket 112.

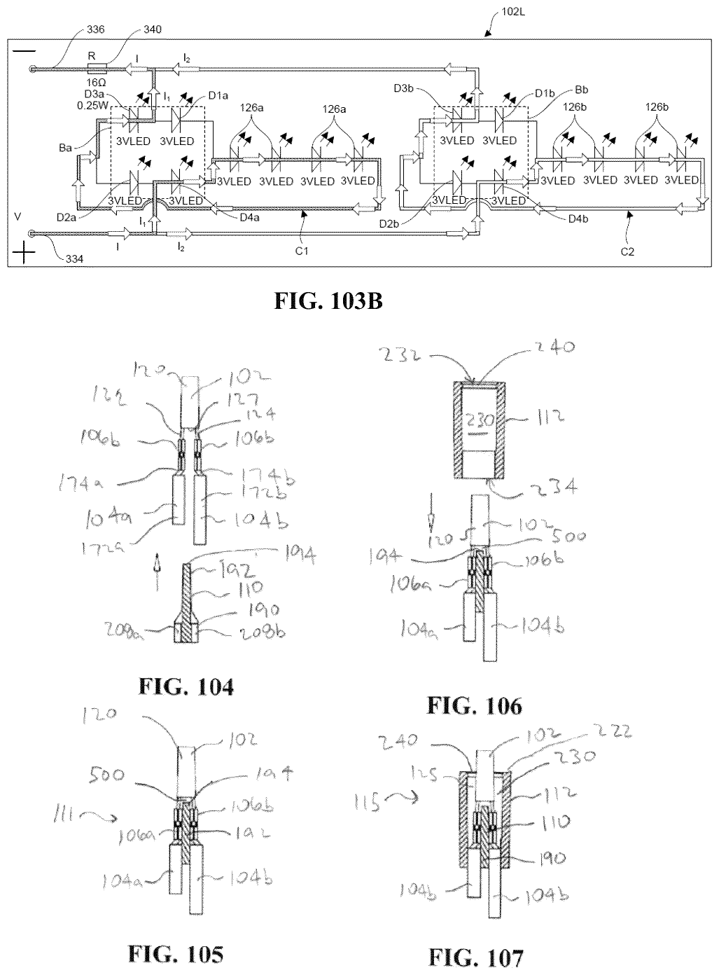

In addition to “long-bulb” LED bulb 102L embodiments depicted and described above with respect to FIGS. 91-96, additional embodiments of LED bulb 102L are depicted in FIGS. 102A to 103B. For the sake of brevity, FIGS. 102A to 103B depict the electrical circuits associated with particular embodiments of LED bulb 102L, and it will be understood that bulbs 102L according to these circuits include the lead frames, PC board and other necessary hardware described above with respect to other embodiments of LED bulb 102L.

Referring now to FIGS. 102A and 102B, an electrical circuit of an embodiment of LED bulb 102L optimized for receiving AC power is depicted. FIG. 102A depicts the circuit with a first or positive-half AC waveform applied, and FIG. 102B depicts the circuit with a second or negative-half AC waveform applied. Arrows indicate a direction of current flow, and the letter “I” indicates current. In this embodiment, each LED 126 is a 3V LED, though other LEDs with different operating or bias voltages may be used.

Referring specifically to FIG. 102A, a positive amplitude AC voltage is applied across lead frame 336 and lead frame 334. In this embodiment, the electrical circuit of LED bulb 102L includes lead frame 336, lead frame 334, bypass element 340 and a plurality of LEDs 126. In this embodiment, bypass element 340 is a 39 ohm resistor, and there are 16 3V LEDs 126. Eight LEDs 126a of the 16 LEDs are oriented in a first polarity, and the other eight of the 16 LEDS, LEDs 126b, are oriented in a second, opposite polarity, forming pairs 127 of back-to-back LEDs 126. Although 16 LEDs are depicted, it will be understood that more or fewer LEDs 126 may be included in lamp LED 102L for more or less light emission, and depending on whether heat generated by LEDs 126 is a limiting factor.

As depicted, anodes of LEDs 126a are connected to lead frame 336 and cathodes of LEDs 126b are connected to lead frame 334. Anodes of LEDs 126b are connected to lead frame 334 and cathodes of LEDs 126b are connected to lead frame 336. When power is applied, LEDs 126a are forward biased, current Ix flows through each LED 126a and each LED 126a emits light. Current Ix generally refers to a first, second, third and so on, LED current, e.g., 11, 12, 13 and so on. Total current flow through lamp 102L is indicated as I_{Total}.

While the positive AC waveform is applied, LEDs 126b are reversed biased and do not conduct current or emit light.

Referring to FIG. 102B, the same LED lamp 102L electrical circuit with a negative amplitude AC voltage is applied across lead frame 336 and lead frame 334. When power is applied, LEDs 126b are forward biased, current Ix flows through each LED 126a and each LED 126a emits light.

With this “back-to-back” arrangement, lamp 102L is configured to emit light during both the positive and negative cycles of an applied AC power source.

Further, the use of pairs of back-to-back LEDs 126 as depicted can improve corrosion-resistance properties of LED lamp 102L by decreasing leakage current between LEDs 126 as compared to placing conducting LEDs 126 adjacent one another.

Referring to FIGS. 103A and 103B, an electrical circuit for another embodiment of multi-diode LED lamp 102L is depicted. Similar to the embodiment of FIG. 94, in the embodiment of FIGS. 103A and 103B, the electrical circuit of lamp 102L is configured to receive AC power, and includes one or more diode bridges. Unlike FIG. 94, the embodiment of lamp 102L of FIGS. 103 uses LEDs for the rectifying diodes in the diode bridge, includes two electrical circuits in parallel, C1 and C2, each electrical circuit including a rectifying diode bridge B (Ba for C1 and Bb for C2), with each circuit also including a plurality of LEDs 126 electrically connected in series. Multi-LED lamp 102L also includes first and second lead frames 334 and 336, and may include optional bypass element 340, which in this embodiment is a resistor, such as the 16 ohm resistor depicted.

More specifically, electrical circuit C1 includes first rectifying diode bridge Ba that includes diodes D1a, D2a, D3a and D4a arranged as depicted. In this embodiment, each of diodes D1a, D2a, D3a and D4a is a light-emitting diode, which may be the same as an LED 126. Diode bridge Ba is electrically connected to a plurality of LEDs 126a, four in this embodiment, which are electrically connected to one another in series.

Similarly, electrical circuit C2 includes second rectifying diode bridge Bb that includes diodes D1b, D2b, D3b and D4b arranged as depicted. In this embodiment, each of diodes D1b, D2b, D3b and D4b is a light-emitting diode, which may be the same as an LED 126. Diode bridge Bb is electrically connected to a plurality of LEDs 126b, four in this embodiment, which are electrically connected to one another in series.

As depicted in FIG. 103A, when a positive half of an AC waveform is applied to lead frames 334 and 336, current flows as indicated by the arrows, with I₁ being the current through circuit C1, I₂ being the current through circuit C2. The applied voltage V is equal to the sum of I₁ and I₂ times resistance of bypass element R, plus the sum of the voltage drops across two of the diode bridge Ba diodes and the voltage across each of the four LEDs 126a. In this manner, AC voltage source requirements can be determined by summing the LED voltage drops and a voltage drop across bypass element 340. Further, D3a, D4a, and each of LEDs 126a are effectively connected in series, are each positively biased, and each emit light.

Referring to FIG. 103B, when a negative half of an AC waveform is applied to lead frames 334 and 336, current flows as indicated by the arrows, with I₁ being the current through circuit C1, I₂ being the current through circuit C2. As with FIG. 103A with positive voltage applied, the applied voltage V is equal to the sum of I₁ and I₂ times resistance of bypass element R, plus the sum of the voltage drops across two of the diode bridge Ba diodes and the voltage across each of the four LEDs 126a. Further, D1a, D2a, and each of LEDs 126a are effectively connected in series, are each positively biased, and each emit light.

Circuit C2 operates the same as circuit C1 as described above.

Such embodiments of multi-diode LED lamp 102L may be used as the LED lamp of the various LED lamp assemblies, including LED lamp assembly 100, as described above. LED lamp 102L may also be used with the LED lamp assemblies described below with respect to FIGS. 104 to 120.

Referring to FIGS. 104 to 112, an embodiment of an LED lamp assembly 100 having a cavity-filling sealing material 508 is depicted. Generally, and as explained further below, rather than coating electrically-conductive components, such as lead frames 12, 124, 334, 336, terminals 106, and so on, with conformal coating 108 prior to assembling with a lamp socket, such as lamp socket 112 and separator 110, in this embodiment, LED lamp assembly 100 may be partially or fully assembled without initially coating electrically-conductive components, followed by an addition of sealing material 508 into socket 112 to fill space in receiving cavity 230 of lamp socket 112 and coat all or most portions of electrically-conductive components.

Referring specifically to FIGS. 104 and 105, and similar to FIGS. 12 and 35, first uninsulated (conductive) portion 174a of wire 104a is electrically and mechanically connected to first polarity lead frame 122 of LED lamp 102 with first electrical connector 106a. Although reference is made to LED lamp 102, it will be understood that the LED lamp of this embodiment may alternatively include any of the variations of LED lamp 102 described above, including multi-diode LED lamp 102L. Second uninsulated (conductive) portion 174b of wire 104b is electrically and mechanically connected to second polarity lead frame 124 of LED lamp 102 with second electrical connector 106b.

Separator 110, depicted in cross section as it is also in FIG. 13, is moved into position between wires 104a and 104b, such that channels 208a and 208b receive insulated portions 172a and 172b of wires 104a and 104b, respectively. Upper portion 192 is positioned between uninsulated portions 174a and 174b, between terminals 106a and 106b, and in some embodiments, between first polarity lead frame 122 and second polarity lead frame 124, thereby separating first and second electrical polarity conductive components, as described in further detail above.

In an embodiment, and as depicted, upper end 194 of separator 110 may not be positioned directly adjacent to, and in contact with, a bottom surface of lens 120, unlike the embodiment depicted in previous figures, including FIGS. 14, 21 and others. Rather, in this embodiment, upper end 194 may be displaced in a vertical direction to leave cavity gap 500 in lamp-receiving cavity 518 between lower surface 127 of lens 120 and upper end 194 of separator 110. As explained further below, gap 500 may be filled with sealing material 508 to minimize potential conductive paths between lead frame 122 and lead frame 124.

In the subassembly of FIG. 105, conformal coating 108 has not been applied. This subassembly of components is referred to as subassembly 111 for the sake of explanation. Alternatively, in an embodiment, conformal coating 108 may be applied, and sealing material 508 later added to cavity 230, particularly if lamp socket 112 is relatively large, such that coated components would not impede flow of sealing material 508 throughout cavity 530.

Referring to FIGS. 106-108, lamp socket 112 is assembled to subassembly 111. In an embodiment, subassembly 111 is inserted through bottom opening 234 of lamp socket 112 and into receiving cavity 230 of lamp socket 112. Lower portion 190 of separator 110 is fit into bottom opening 234 of lamp socket 112, as was explained above in a previous embodiment. The subassembly of FIG. 107, for the sake of convenience, is referred to as subassembly 115.

Referring also to FIG. 109, after subassembly 115 is prepared, sealing material 508 may be inserted into receiving cavity 230 of lamp socket 112. As described above, lamp socket 112 includes upper end 222 which may include cap-retention ring 240, and which defines top opening 232. Lens 120 of LED lamp assembly 102 projects through top opening 232, filling some of the space defined by top opening 232, leaving filling gap 504 between lamp socket 112 and lens 120. When opening 232 is circular and lens 120 is cylindrical, filling gap 504 may form an annular ring. Filling gap 504 may form other shapes, depending on the shape of top opening 232 and lens 120.

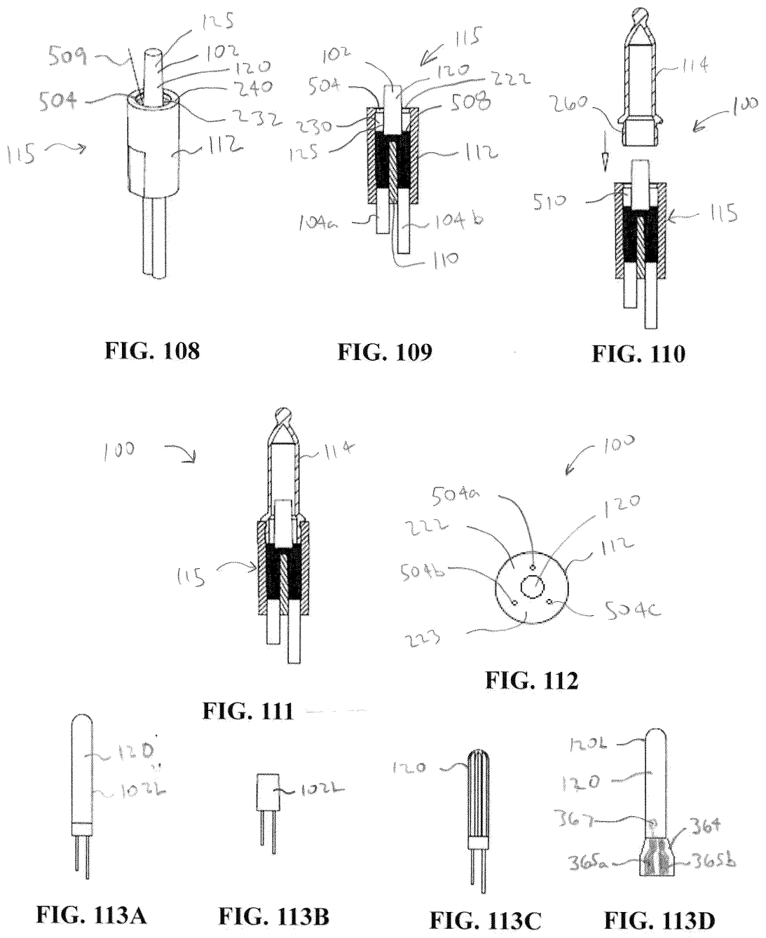

Filling gap 504 is configured to receive sealing material 508 and/or a sealing-material delivery device 509, such as a needle, hollow tube, and so on (depicted as a needle in FIG. 108. Sealing-material delivery device 509 may be inserted at or through filing gap 504 such that sealing material 508 may be delivered into, or received by, socket cavity 230. Sealing material 508 may be delivered under pressure, such as from a dispenser, causing sealing material 508 to flow into cavity 230 and surround the electrically-conductive components in 230. Gravity may also assist in causing sealing material to flow throughout cavity 230.

A function of sealing material 508 is to fill all or most of any remaining space within receiving cavity 230 after adding subassembly 111, i.e., separator 110, lamp 102, wires 104, electrical connectors 106 and lead frames 122, 124, and to cover or coat electrically-conductive portions of subassembly 111, e.g., lead frames, connectors, conductors. Another function of sealing material 508 is to adhere the components of subassembly 111 to one another and to lamp socket 112, adding structural integrity to subassembly 115.

In an embodiment, sealing material 508 may be the same as, or similar to, conformal coating 108 as described above. In an embodiment, sealing material 508 may comprise any of a variety of glues, adhesives, sealants, and so on that will conform to the contours of cavity 230 and to the surface of the various exposed conductive, metal components of the subassembly 111 of LED bulb assembly 102, including uninsulated metal conductor portions 174, metal conductor-lead-frame connectors 106 and portions of lead frames 122 and 124, and protect such components from moisture and subsequent corrosion. In an embodiment, sealing material 508 may comprise urethane, epoxy acrylic, or silicone, which may be in epoxy form, or may comprise parylene, though other materials are contemplated, such as ultraviolet (UV) light-cured adhesive or sealant, or AB gel or epoxy. In an embodiment sealing material 508 comprises a sealing material that when exposed to UV-light changes from liquid or gel form to a substantially or fully cured or solid form.

Being in a liquid or gel form, sealing material 508 when delivered into or injected into cavity 230 may flow into substantially all of the spaces around the electrically-conductive components of subassembly 111, covering the conductive components, thereby closing any potential moisture paths and preventing movement of components that might cause unwanted contact and electrical shorting.

In an embodiment, tolerances of bottom portion 190 of separator 110 and opening 234 of lamp socket 112 may allow for some space between bottom portion 190 and socket 112, such that insertion of bottom portion 190 into opening 234 and into cavity 230 does not create an airtight seal. In other words, there may be some gaps between bottom portion 190 and lamp socket 112 and between bottom portion 190 and wires 1104. In such an embodiment, sealing material 508 may be inserted into cavity 230, causing sealing material 508 to flow into and fill such gaps, thereby sealing and securing bottom portion 190 to lamp socket 112 and wires 104, including to insulated wire portions 172a and 172b.

Further, in some embodiments, separator 110 may include only bottom portion 190, and may not include upper portion 192, thereby separating insulated wire portions 172a and 172b from one another, though in some embodiments not extending up and between uninsulated portions 174a and 174b. In such an embodiment, separator 110 may more aptly described as a plug positioned in opening 234 of lamp socket 112. Although upper portion 192 provides additional physical separation between conductive components within cavity 230, the absence of upper portion 192 may not be significant as sealing material 508 will cure or harden and isolate the components, thereby saving material costs.

In another embodiment, separator 110 may include upper portion 192, but separator portion 110 and upper portion 192 might not be inserted into cavity 230 until after sealing material 508 is received into cavity 230.

In an embodiment wherein sealing material 508 is cured with UV light, after sealing material 508 is injected into cavity 230, UV light is directed through filling gap 504 to cure sealing material 508. In such an embodiment, UV light may enter through filling gap 504 and reflect on inner surfaces of lamp socket 112 and conductive components to reach and cure sealing material 508 not within a direct line of sight of filling gap 504.

Referring also to FIG. 112, another embodiment of lamp socket 112 with lens 120 is depicted. In this embodiment, lamp socket 112 may define a plurality of discrete, separate small holes or openings 504, including 504a, 504b and 504c, rather than one continuous filling gap 504. In an embodiment, LED lamp assembly 100 may or may not include a cover 114. As depicted in the embodiment of FIG. 112, LED lamp assembly 100 does not include cover 114. In this embodiment, top surface 223 of top portion 222 of lamp socket 112 defines a plurality of fill openings 504a, 504b and 504c. Lens 120 is located adjacent to lamp socket 112, without a gap, or at least without a substantial gap, between lens 120 and lamp socket 112.

In the depicted embodiment, top surface 223 defines three fill openings 504, but more or fewer openings may be defined, depending on various factors, including an amount of sealing material 508 to be injected into cavity 230, the size of fill openings 504, diameter of sealing material delivery devices 509 inserted into gap 504, and so on. In an embodiment, sealing material 508 is delivered into cavity 230 through one or more filling openings 504 and UV light is directed through one or more filling openings 504 simultaneously or thereafter to cure sealing material 508.

In an embodiment, the use of multiple fill openings allows sealing material 508 to be inserted into one or fewer than all fill openings 504, which allows displaced air to exit cavity 230 through the one or more unused fill openings 504. Similarly, when lamp assembly 115 defines a single fill opening 504, a sealing material delivery device, such as a needle or hollow tube, may not fill the entire fill opening 504 area, such that cavity air may be displaced as sealing material 508 flows into cavity 230.

Alternatively, fill opening 504 may be configured to tightly receive sealing material delivery device 509, such that fill opening 504 is substantially sealed. In such an embodiment, air in cavity 230 may escape cavity 230 when sealing material 508 is delivered into cavity 230 through other exit openings. In one such embodiment, air escapes through lower opening 234 of lamp socket 112 in one or more gaps between lamp socket 112 and lower portion 190 of separator 110.

Referring again to FIG. 109, in an embodiment, sealing material 508 may substantially fill cavity 230. This may include filling a space between separator 110 upper end 194 and lens 120, which may also include sealing material surrounding and contacting a portion of outer side surface 125, which can provide structural integrity to LED lamp assembly 100 by fixing the position of LED lamp assembly 102 within lamp socket 112.

Referring also to FIG. 110-111, in an embodiment, cavity 230 may be entirely filled such that there is substantially no space or air gaps in cavity 230 of lamp socket 112, and such that cavity 230 is filled up to filling gap or opening 504. In other embodiments, and as depicted, cavity 230 may be substantially filled, but not completely filled, leaving some space about a portion of lens 120 to accommodate insertion of lamp cover 114. In such an embodiment, lamp socket 112 in combination with lens 120 and sealing material 508 may define cover-receiving portion or channel 510 configured to receive lower portion 260 of cover 114.

Referring to FIGS. 113A to 120, embodiments of large lamp-base LED lamp assemblies 100 and components thereof are depicted.

Referring to FIGS. 113A, 113B, 113C and 113D, embodiments of multi-LED large LED lamps 102L are depicted. FIG. 113C depicts a multi-LED lamp assembly 102L substantially similar to LED lamp assembly 102L of FIGS. 77-82. LED lamp assembly 102L of FIG. 113A is similar to LED assembly 102L of FIG. 113C, though rather than having a striated external lens, LED lamp assembly 102L of FIG. 113A may form smooth, cylindrical shape for a more uniform light dispersion and emission. In another embodiment, multi-LED lamp 113A may comprise a phosphor coating that forms a cover 120 over its electrical components.

FIG. 113D depicts an embodiment of multi-LED lamp 102 that includes PCB-substrate-based conductor platform 364 with conductive portions 365a and 365b for connecting to an external power source, also referred to as first and second power-connection portions. In this embodiment, multi-diode LED lamp 102 may also include a plurality of LEDs 126 electrically connected in series or parallel or a combination thereof, one or more diode bridges B (see FIGS. 102 and 103), controller 367, and/or bypass element 340. These electrical components may be arranged to form any of a variety of electrical circuits, including one of the electrical circuits described herein, such as in FIGS. 91-92 and 102-103.

As depicted, the embodiment of multi-LED lamp 102 of FIG. 113D includes cover 120, which may also be a cover similar to that described with respect to lamp 102L of FIG. 113A. Cover 120 in this embodiment only covers a portion of substrate 364. This is advantageous because the uncovered portion of substrate 364 can be inserted into, or otherwise assembled to, a lamp socket, such as lamp socket 112, which would cover and protect the exposed portion of PCB 364 and its conductive portions, such as conductive traces 365. This arrangement also makes conductive traces 365 available to be connected to an external power source, such as via wires 104.

Multi-LED lamp assemblies 102L of the disclosure may be configured to operate on DC or AC power, as described above, at varying voltages depending on the number of LEDs 126 and electrical configuration, such as at 5V, 12V or 24V, though other operating voltages are contemplated. In some embodiments, an electrical transformer or adapter that steps an incoming AC voltage down to a lower AC voltage may be used to power a plurality of LED lamps 102, LED lamp assemblies 100 and light strings comprised thereof.

LED lamp 102L of FIG. 113B may comprise a single LED 126 or a plurality of LEDs 126, and may include a shorter length lens as compared to the embodiments of FIGS. 113A and 113C.

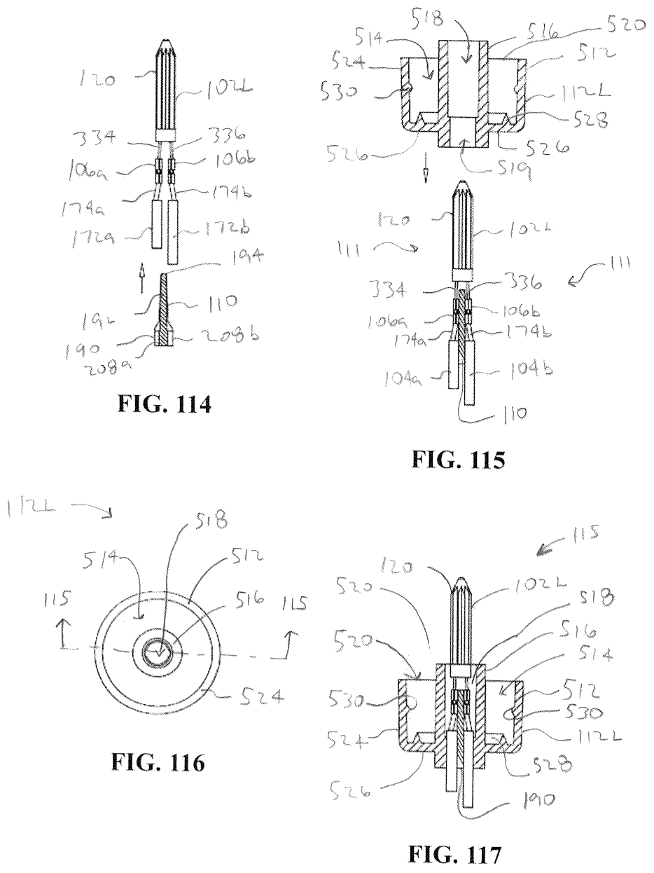

Any of the multi-LED lamps 102L of FIGS. 113A, 113B and 113C may be paired with the wire and socket combinations described above, but may also be combined with a large lamp socket and large cover to form large-base, large-socket LED lamp assemblies 100 as depicted in FIGS. 114 to 120. Embodiments of large-base, large-socket LED lamp assemblies 100 of FIGS. 114 to 120 may be configured to include sealing material 508 to minimize leakage currents and subsequent corrosion of electrically-conductive components, such as lead frames, electrical connectors, wire conductors and so on, similar to the embodiments of FIGS. 104 to 112, such that the description of LED lamp assemblies 100 of FIGS. 104 to 112 also applies.

Referring specifically to FIGS. 114-115, first uninsulated portion 174a of wire 104a is electrically and mechanically connected to first polarity lead frame 334 of LED lamp 102L with first electrical connector 106a. Second uninsulated portion 174b of wire 104b is electrically and mechanically connected to second polarity lead frame 336 of LED lamp 102 with second electrical connector 106b.

Separator 110, depicted in cross section as it is in FIG. 13, is moved into position between wires 104a and 104b, such that channels 208a and 208b receive insulated portions 174a and 174b of wires 104a and 104b, respectively. Upper portion 192 is positioned between uninsulated portions 174a and 174b, between terminals 106a and 106b, and in some embodiments, between first polarity lead frame 334 and second polarity lead frame 336, thereby separating first and second electrical polarity conductive components, as described in further detail above.

In the subassembly of FIG. 115, conformal coating 108 has not been applied. This subassembly of components is referred to as subassembly 111 for the sake of explanation.

FIG. 115 depicts a large-cover lamp socket 112L in cross section, while FIG. 116 depicts a top view of large-cover lamp socket 112L. As depicted the lamp socket, socket 112L, varies from lamp socket 112 as previously depicted and described. In this embodiment, lamp socket 112L is configured to not only receive subassembly 111 with LED lamp 102, wires 104, and connectors 106, but is also configured to receive a large lamp cover, lamp cover 114L, which is configured to fit over and around LED lamp 102L.

In an embodiment, and as depicted lamp socket 112L includes outer body portion 512 defining cover-base receiving cavity 514 and inner body portion 516 defining lamp-wire-receiving cavity 518.

Referring also to FIG. 117, outer body portion 512 may be generally cylindrical and define opening 520, which is an opening into cover-base receiving cavity 514. Cover-base receiving cavity 514 may form an annual ring or channel when inner body portion 516 forms a cylinder with a circular outer circumference. Cover-base receiving cavity 514 is configured to receive a portion, such as a base or lower portion 522 of lamp cover 114L (see FIG. 119). In an embodiment, outer body portion 512 may include cylindrical, vertically-extending wall 524 that extends circumferentially about inner body portion 516, and bottom portion 526 that may form an annular ring and extend generally transverse, or in some embodiments, perpendicular to wall 524. Bottom portion 526 may include ridge 528, which may be an annular ridge, that extends vertically upward from bottom portion 526 and extends circumferentially about bottom portion 526. In an embodiment where large cover 114L is a screw-in or threaded cover, outer body portion 512 may also include one or more ridges or threads 530 to engage with cover 114L.

Inner body portion 518 defining lamp-receiving cavity 518 is similar in function, and to a certain extent structure, of lamp socket 112 defining cavity 230, with lamp-receiving cavity 518 configured to receive subassembly 111. Similarly, subassembly 111 is assembled to large cover lamp socket 112L to form subassembly 115, such that electrically-conductive components lead frames 334, 336, connectors 106, conductors 174, as well as upper portion 194 of separator 110 are located in lamp-receiving cavity 518. Bottom portion 190 with wires 104 fill in opening 519 of inner body portion 518. In an embodiment, and as depicted, a portion of lens 120 may be within lamp-receiving cavity 518, though in other embodiments, lens 120 may be located entirely outside of lamp-receiving cavity, such as in an embodiment where it is desirable to have LEDs 126 further away from lamp socket 112L for purposes of unobstructed radiation of light.

As depicted in FIG. 117, sealing material 508 and large cover 114L are not yet assembled to subassembly 115. Further, in an embodiment, and as depicted, lamp-receiving cavity 518 and cover-base-receiving cavity 514 are separated from one another by means of inner body 516 and are not in fluid communication with one another.

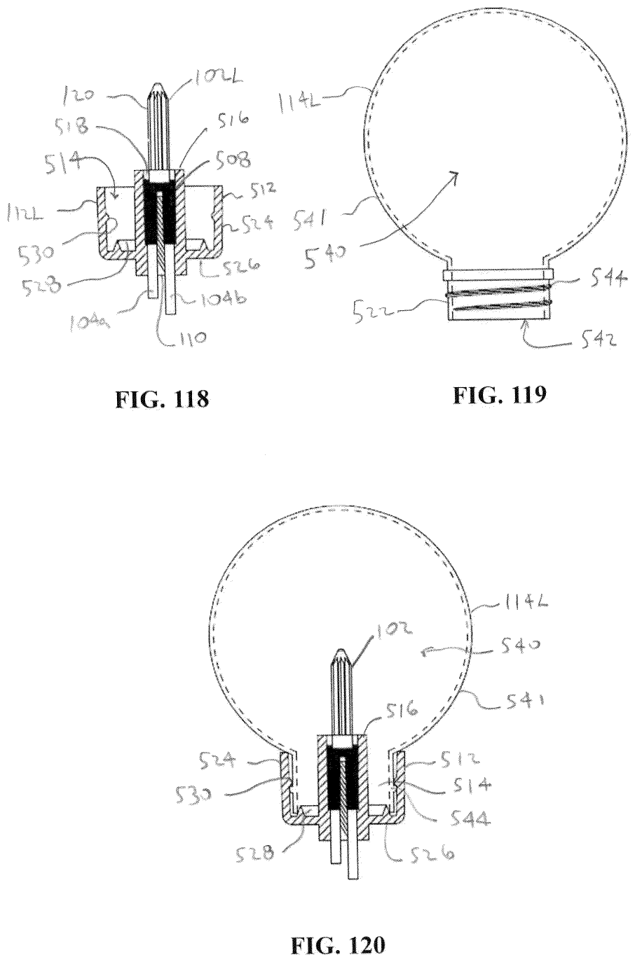

Referring to FIG. 118, sealing material 508 is added to inner body portion 516 lamp-receiving cavity 518 to fill a majority of cavity 518 and to cover electrically-conductive components 334, 336, 106, and 174, as described above with respect to FIG. 109.

In this embodiment, as will be described further below, and unlike the embodiment of FIGS. 104 to 112, large cover 114L is not adhered to lamp socket 112L via sealing material 508.

Referring to FIG. 119, an embodiment of large cover 114L is depicted. In an embodiment, and as depicted, large cover 114L defines cover cavity 540 and includes base portion 522 and main portion 540. In an embodiment, base portion 522 defines opening 542 which is an opening to cover cavity 540. In an embodiment, base portion 522 may be a threaded base as depicted, and therefore include exterior thread or threads 544 configured to engage interior thread 530 of large lamp socket 112L. In other embodiments, large cover 114L may comprise a push-in type cover or other non-threaded cover 114L.

Main portion 541 may be spherical, as depicted, such as a globe cover, or may form other shapes, such as candelabra shapes and other shapes.

Referring also to FIG. 120, large cover 114L is depicted as assembled to large-cover lamp socket 112L. Base portion 522 is received into cavity 514 of outer body portion 512 and in contact with bottom portion 526, cover thread 544 is engaged with lamp socket 112L internal thread 530, ridge 528 is received into a portion of cover cavity 540 to assist in sealing cover cavity 540.

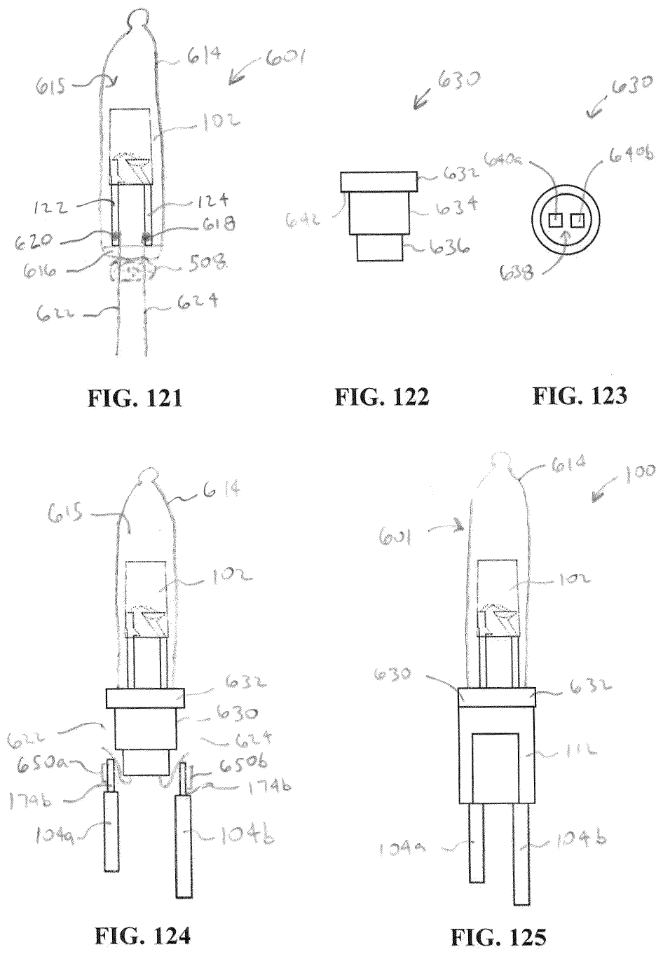

Referring to FIGS. 121-125, another embodiment of a corrosion-resistant LED lamp assembly 100 is depicted. In an embodiment, LED lamp assembly 100 includes enclosed LED lamp assembly 601, which includes LED lamp assembly 102, as described above, enclosed in cover 614, with first lead-frame extension conductor 622 connected to first-polarity lead frame 122, second-polarity lead frame extension conductor 624 connected to second-polarity lead frame 124 and optional sealing material 508.

In an embodiment, cover 614 covers and encloses LED lamp 102, defines cavity 615, and includes cover base 616 and main portion 617. In an embodiment, cover 614 comprises a glass material shaped to resemble a traditional “mini” bulb as is commonly used in incandescent lights. When cover 614 is made of a glass material, i.e., comprises a glass bulb, the lighting effect of LED lamp 102 can more closely resemble that of a traditional incandescent mini light bulb. In alternate embodiments, cover 614 may comprise a plastic or polymer, such as a polyethylene material.

In an embodiment, first lead-frame extension conductor 622 connected to first-polarity lead frame 122 may comprise a flexible conductor, such as a single-strand Dumet wire, commonly used in incandescent bulbs. Similarly, second-polarity lead frame extension conductor 624 connected to second-polarity lead frame 124 may also comprise a flexible conductor, such as a single-strand Dumet wire.

Although extension conductors other than Dumet wires may be used, when cover 614 comprises a glass bulb, Dumet wires facilitate the sealing of the glass bulb or envelope at cover base 622. As those of ordinary skill will understand, Dumet is a glass-to-metal sealing alloy that when used with glass bulbs, will create a seal between the glass and the conductor. The use of Dumet wire for extension conductors 622 and 624 in combination with glass bulb or cover 614 provides another way to seal electrically-conductive components of LED lamp assembly 102, by preventing water from penetrating into cover 614.

First lead-frame extension conductor 622 is connected to first-polarity lead frame 122 at connection joint 620, and second-polarity lead frame extension conductor 624 is connected to second-polarity lead frame 124 at connection joint 618. Connection joints 618 and 620 comprise solder joints, or alternatively may comprise a mechanical connector, such as crimp connectors. When connections joints 618 and 620 are contained within cover 614, the joints are protected from mechanical interference, and if interior 615 forms a vacuum seal, joints 618 and 620, as well as the other electrically-conductive portions are not subject to oxidation.

In an embodiment, and as depicted, LED lamp assembly 100 may also include optional sealing material 508 at cover base 616. Including sealing material 508 at base 616 may help ensure that interior 615 of cover 614 is sealed, and forms a further mechanical separation between first lead-frame extension conductor and second-polarity lead frame extension conductor 624, which may be beneficial to maintaining separation of conductor when LED lamp 102 is inserted into lamp base 630 as described below.

Referring also to FIGS. 122-125, in addition to LED lamp 102, LED lamp assembly 100 also includes lamp base 630, wires 104a and 104b, and lamp socket 112.

Referring specifically to FIGS. 122 and 123, a front view and a top view of lamp base 630 are depicted. In an embodiment, lamp base 630 includes upper portion 632, middle portion 634 and lower portion 636. Lamp base 630 defines lamp-receiving cavity 638 which may extend through top portion 632 and middle portion 634. Lamp-receiving cavity 638 may or may not extend into lower portion 636, depending in part on a length of cover 614. Lower portion 636 defines a pair of extension-conductor holes 640, including holes 640a and 640b, configured to receive first lead-frame extension conductor 622 and second-polarity lead frame extension conductor 624, respectively.

Lamp base 630, in an embodiment comprises a polymer material, such as PVC, PP or another polymer, similar to the material of lamp socket 112.

Upper portion 632 may form an annular ring, having bottom surface 642 configured to seat against a top surface of lamp socket 112. Middle portion 634 may form step 644 configured to seat against a stop surface (not depicted) within lamp socket 112.

Referring also to FIG. 124, enclosed LED lamp assembly 601 is assembled to lamp base 630. A lower end of cover 614, including base portion 616 is received into lamp base 630 cavity 638; extension conductors 622 and 624 are inserted through holes 640a and 640b, causing the to extend out of lamp base 630. In an embodiment, and as depicted, extension conductors 622 and 624 may be bent upwards along lower portion 636 to position them for contact with uninsulated portions (conductive portions) 174a and 174b of wires 104a and 104b, respectively. Conductive portions 174a and 174b may also include connectors 650a and 650b attached to ends of conductive portions 174a and 174b. Connectors 650a and 650b may comprise crimp terminals that are crimped to conductive portions 174a and 174b, and that may also be crimped to insulated portions 172a, 172b of wires 104a and 104b. Connectors 650a and 650b when present are in contact with extension conductors 622 and 624, respectively. Connectors 650a and 650b may be used to mechanically anchor wires 104a and 104b to lamp socket 112, such as by inserting connectors 650a and 650b into receiving slots or openings in cavity 230 of lamp socket 112. Alternatively, when connectors 650a and 650b are not present, extension conductors 622 and 624 may make direct contact with conductive portions 174a and 174b.

Referring also to FIG. 125, enclosed LED lamp assembly 601 and lamp base 630 are received into lamp socket 112, as are conductive portions 174a, 174b of wires 104a and 104b to form this embodiment of corrosion-resistant LED lamp assembly 100.

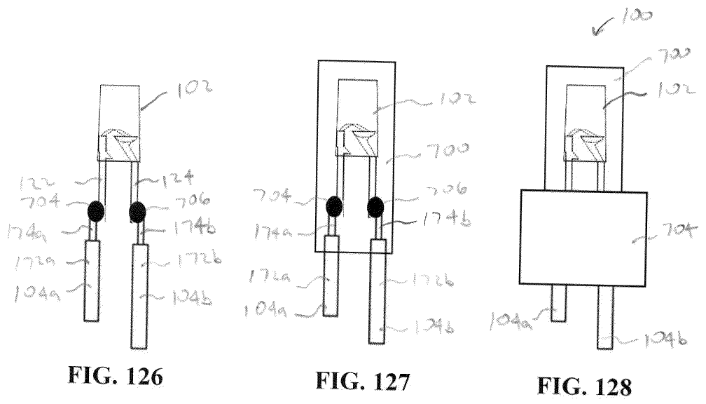

Referring to FIGS. 126-128, another embodiment of corrosion-resistant LED lamp assembly 100 is depicted. In this embodiment, LED lamp assembly 100 includes LED lamp 102, wires 104a and 104b, overmolded cover 700 and overmolded base portion 702.

Referring specifically to FIG. 126, in an embodiment, first-polarity lead frame 122 of LED lamp 102 is mechanically and electrically connected at joint 704 to conductive portion 174a of wire 104a. Second-polarity lead frame 124 of LED lamp 102 is mechanically and electrically connected at joint 706 to conductive portion 174b of wire 104b. In an embodiment, joints 704 and 706 comprise solder joints, though in other embodiments, joints 704 and 706 may comprise electrical connectors, such as crimp or other connectors.

Referring also to FIG. 127, in an embodiment, overmolded cover 700 is molded onto or over LED lamp 102, joints 704 and 706, conductive wire portions 174a and 174b and portions of first and second insulation portions 172a and 172b. In an embodiment, overmolded cover 700 comprises a polymer material, such as PE, an epoxy, resin or other such material. The material of overmolded cover 700 may be transparent or translucent so that light from LED lamp 102 penetrates through the material and out of overmolded cover 700. When overmolded cover 700 is molded onto LED lamp 102 and wires 104 as depicted, the cover material surrounds and covers lens 102 and the depicted portions of wires 104, thereby sealing these components from moisture and eliminating or reducing the possibility of leakage current between electrically-conductive components of opposite polarity, and thereby eliminating or reducing possible corrosion.

Referring also to FIG. 128, after molding overmolded cover 700 onto LED lamp 102, base 702 is molded or overmolded onto overmolded cover 700 and insulated portions 172a and 172b of wires 104a and 104b, respectively. In an embodiment, base 702 comprises a polymer or plastic material, such as polypropylene (PP), polyvinyl chloride (PVC) or similar material. In one such embodiment, base 702 comprises an opaque material. Overmolding base 702 onto overmolded cover 700 and wires 104 adds structural strength to LED lamp assembly 100, further stabilizes wires 104a and 104b, and covers or hides the appearance of joints 704 and 706, improving the aesthetic appearance of LED lamp assembly 100.

Embodiments of the above-described LED lamps, LED lamp assemblies, light strings, and methods of manufacturing thereof, reduce or eliminate leakage current between opposite-polarity live electrical parts and minimize water intrusion into the LED lamps and LED lamp assemblies, thereby reducing or eliminating corrosion of conductive components of the lamp assembly, including LED lead frames, wire conductors and connectors.

The following clauses illustrate example subject matter described herein.
Clause 1. A light-emitting diode bulb, comprising:
   a first-polarity lead frame comprising a conductive metal material and having an upper portion with a top surface and having a lower portion; a second-polarity lead frame comprising a conductive metal material and having an upper portion with a top surface and having a lower portion, wherein the upper portion of the second-polarity lead frame is displaced from the upper portion of the first-polarity lead frame to form a gap therebetween; an electrical bypass element mounted to the top surface of the upper portion of the first-polarity lead frame, the electrical bypass element having a first portion electrically connected to the first-polarity lead frame, and a second portion electrically connected to the second-polarity lead frame via a first connecting conductor that spans the gap between the upper portion of the first-polarity lead frame and the upper portion of the second-polarity lead frame; a light-emitting diode (LED) mounted to the top surface of the upper end of the second-polarity lead frame, the LED having an anode and a cathode, the anode electrically to one of the first-polarity lead frame or the second-polarity lead frame, and the cathode electrically connected to the other of the first-polarity lead frame or the second polarity lead frame by a second connecting conductor that spans the gap between the upper portion of the first-polarity lead frame and the upper portion of the second-polarity lead frame, such that the LED and the electrical bypass element are electrically connected in parallel; and a lens encapsulating the upper portion of the first-polarity lead frame, the upper portion of the second-polarity lead frame, the bypass element, the LED, the first connecting conductor and the second connecting conductor, the lens including a lower surface from which the lower portion of the first lead frame projects and from which the lower portion of the second lead frame projects.
Clause 2. The light-emitting diode bulb of clause 1, wherein the bypass element is a resistor.
Clause 3. The light-emitting diode bulb of clause 2, wherein the resistor is a chip resistor
Clause 4. The light-emitting diode bulb of clause 1, wherein the bypass element is a Zener diode.
Clause 5. The light-emitting diode bulb of clause 1, wherein the LED comprises an LED package that includes a semiconductor chip.
Clause 6. The light-emitting diode bulb of clause 5, wherein a bottom portion of the LED chip is mounted to the second-polarity lead frame.
Clause 7. The light-emitting diode bulb of clause 6, wherein the bottom portion of the LED chip is mounted to the second-polarity lead frame via a conductive material.
Clause 8. The light-emitting diode bulb of clause 7, wherein the conductive material is solder or conductive paste.
Clause 9. The light-emitting diode bulb of clause 1, wherein the LED is configured to emit a single color light.
Clause 10. The light-emitting diode bulb of clause 1, wherein the LED is a red-green-blue (RGB) LED configured to emit red, green or blue light, or a combination thereof.
Clause 11. The light-emitting diode bulb of clause 1, wherein the lens comprises a transparent or semi-transparent material.
Clause 12. The light-emitting diode bulb of clause 11, wherein the material comprises an epoxy material.
Clause 13. A light-emitting lamp assembly, comprising the LED bulb of clause 1, a lamp socket, a separator, a pair of connectors and a cover.
Clause 14. The light-emitting lamp assembly of clause 13, further comprising a pair of wires, each wire having an insulation portion and a conductor portion.
Clause 15. The light-emitting lamp assembly of clause 14, wherein each connector of the pair of connectors electrically and mechanically connects one of the first- and second-polarity lead frames to one of the conductors of one wire of the pair of wires.
Clause 16. The light-emitting lamp assembly of clause 15, wherein the mechanical connections are entirely within the lamp socket.
Clause 17. The light-emitting lamp assembly of clause 16, wherein the mechanical connections are crimp connections.
Clause 18. The light-emitting lamp assembly of clause 17, wherein each of the crimp connections does not include crimping to the insulation portion of one of the pair of wires.
Clause 19. A decorative light string comprising a plurality of light-emitting lamp assemblies of clause 17.
Clause 20. A decorative light string, comprising: a power plug configured to connect to a power source for powering the decorative light string; a plurality of light-emitting diode (LED) lamp assemblies configured to receive power from the power plug, each LED lamp assembly including: a lamp socket, a lamp-assembly substrate; plurality of conductive portions on the lamp-assembly substrate, including a first-polarity conductive portion and a second-polarity conductive portion, a plurality of LEDs mounted to the lamp-assembly substrate, the plurality of LEDs electrically connected to one another by the plurality of conductive portions, and a lens encapsulating the plurality of LEDs, a portion of the lamp-assembly substrate, and a portion of the plurality of conductive portions, wherein another portion of the lamp-assembly substrate and a portion of the first-polarity conductive portion and a second-polarity conductive portion extend outside of the lens and into an interior cavity of the socket; and a wire set including a plurality of lamp-connecting wires electrically connecting the plurality of LED lamps to the power plug and to one another.
Clause 21. The decorative light string of clause 20, wherein the lamp-assembly substrate and the plurality of conductive portions comprise a printed circuit board.
Clause 22. The decorative light string of clause 21, wherein the plurality of LEDs include a first group of LEDs and a second group of LEDs, and the LEDs of the first group of LEDs are connected to the substrate and conductive portions on a first side of the substrate, and the LEDs of the second group of LEDs are connected to the substrate and conductive portions on a second side of the substrate, the second side being opposite to the first side.
Clause 23. The decorative light string of clause 20, wherein each LED of the plurality of LEDs is a surface-mount device.
Clause 24. The decorative light string of clause 20, wherein the LED lamp assembly further comprise a resistor chip.
Clause 25. The decorative light string of clause 20, wherein the resistor chip is electrically connected to the plurality of LEDs in series.
Clause 26. The decorative light string of clause 20, wherein the resistor chip is electrically connected to the plurality of LEDs in parallel.
Clause 27. The decorative light string of clause 20, wherein the plurality of LEDs are electrically connected to one another in parallel.
Clause 28. The decorative light string of clause 20, wherein the plurality of LEDs are electrically connected to one another in series.
Clause 29. The decorative light string of clause 28, further comprising a set of four rectifying diodes configured as a rectifying bridge to rectify incoming alternating-current (AC) power.
Clause 30. The decorative light string of clause 29, further comprising a resistor electrically connected to the plurality of LEDs in series.
Clause 31. The decorative light string of clause 30, wherein the plurality of LED lamp assemblies are electrically connected to one another in series.
Clause 32. The decorative light string of clause 31, wherein the power plug is configured to connect to an AC power source.
Clause 33. The decorative light string of clause 31, wherein the substrate has a length greater than a width, and the plurality of LEDs are distributed sequentially along the length of the substrate.
Clause 34. The decorative light string of clause 20, wherein the plurality of LED lamp assemblies includes a first group of LED lamp assemblies and a second group of LED lamp assemblies, and the first group of LED lamp assemblies is electrically connected to the second group of LED lamp assemblies in parallel.
Clause 35. The decorative light string of clause 34, wherein the LED lamp assemblies of the first group are electrically connected to one another in series.
Clause 36. The decorative light string of clause 35, wherein the plurality of LEDs of each lamp assembly of the first group are electrically connected to one another in series.
Clause 37. The decorative light string of clause 35, wherein the plurality of LEDs of each lamp assembly of the first group are electrically connected to one another in parallel.
Clause 38. The decorative light string of clause 35, wherein each LED lamp assembly includes a rectifying bridge comprising a plurality of rectifying diodes.
Clause 38. The decorative light string of clause 37, wherein the rectifying diodes are encapsulated by the LED lens.
Clause 39. The decorative light string of clause 20, wherein each LED lamp assembly includes an integrated-circuit controller configured to control operation of the plurality of LEDs of the LED lamp assembly.
Clause 40. A corrosion-resistant light-emitting diode lamp assembly, comprising: a light-emitting diode (LED) bulb, including: a first-polarity lead frame with an upper portion and a lower portion, a second-polarity lead frame with an upper portion and a lower portion, an LED with an anode electrically connected to the upper portion of the first-polarity lead frame and a cathode electrically connected to the upper portion of the second-polarity lead frame, and a lens encapsulating the LED and the upper portion of the first-polarity lead frame and the upper portion of the second-polarity lead frame, the lens including a lower surface from which the lower portion of the first-polarity lead frame projects and from which the lower portion of the second-polarity lead frame projects; a first wire including a first conductor portion and a first insulation portion, the first insulation portion covering a portion of the first conductor portion such that the first wire has a first insulated wire portion and a first uninsulated conductor portion; a second wire including a second conductor portion and a second insulation portion, the second insulation portion covering a portion of the second conductor portion such that the second wire has a second insulated wire portion and a second uninsulated conductor portion; a pair of conductive crimp connectors, including a first conductive crimp connector and a second conductive crimp connector, wherein the first conductive crimp connector mechanically and electrically connects the lower portion of the first-polarity lead frame to the first uninsulated conductor portion without crimping the first insulation portion of the first wire, and the second conductive crimp connector mechanically and electrically connects the lower portion of the second-polarity lead frame to the second uninsulated conductor portion without crimping the second insulation portion of the second wire; a conformal coating covering the lower portions of the first and second lead frames, the first and second conductive crimp connectors, and the first and second uninsulated conductor portions; a separator having a lower portion and an upper portion, the lower portion defining a first channel receiving a portion of the first insulated wire portion and a second channel receiving a portion of the second insulated wire portion, the upper portion extending from the lower portion between the first uninsulated conductor portion of the first wire and the second uninsulated conductor portion of the second wire, thereby separating the first wire from the second wire, the first conductive crimp connector from the second crimp connector and the lower portion of the first-polarity lead frame from the lower portion of the second-polarity lead frame, an end of the upper portion being adjacent to the lower surface of the lens; a lamp socket defining an upper opening and a lower opening, and including a main portion having an inside surface defining a first channel receiving a portion of the first insulated portion and a second channel receiving a portion of the second insulated portion, wherein the lower opening receives the lower portion of the separator and another portion of the first insulated wire portion and another portion of the second insulated wire portion; and a lamp cover having a lower portion inserted into the upper opening of the lamp socket,
Clause 41. A corrosion-resistant light-emitting diode lamp assembly, comprising: a light-emitting diode (LED) bulb, including: a first conductive structure with an upper portion and a lower portion, a second conductive structure with an upper portion and a lower portion, an LED electrically connected to the upper portion of the first conductive structure and to the upper portion of the second conductive structure, and a lens encapsulating the LED and the upper portion of the first conductive structure and the upper portion of the second conductive structure, the lower portion of the first conductive structure and the lower portion of the second conductive structure projecting from the lens; a first wire including a first conductor portion and a first insulation portion, the first insulation portion covering a portion of the first conductor portion such that the first wire has a first insulated wire portion and a first uninsulated conductor portion; a second wire including a second conductor portion and a second insulation portion, the second insulation portion covering a portion of the second conductor portion such that the second wire has a second insulated wire portion and a second uninsulated conductor portion; a pair of conductive connectors, including a first conductive connector and a second conductive connector, wherein the first conductive connector mechanically and electrically connects the lower portion of the first conductive structure to the first uninsulated conductor portion, and the second conductive crimp connector mechanically and electrically connects the lower portion of the second conductive structure to the second uninsulated conductor portion; a conformal coating covering the lower portions of the first and second lead frames, the first and second conductive connectors, and the first and second uninsulated conductor portions; and a lamp socket including a main portion defining a lamp-socket cavity, wherein the lamp-socket cavity receives a portion of the first insulated wire portion and a portion of the second insulated wire portion, the first uninsulated wire portion and the second uninsulated wire portion.
Clause 42. The corrosion-resistant light-emitting diode lamp assembly of clause 41, wherein the first conductive structure is a first lead frame and the second conductive structure is a second lead frame.
Clause 43. The corrosion-resistant light-emitting diode lamp assembly of clause 41, wherein the first conductive connector is a crimp connector and the second conductive connector is a crimp connector.
Clause 44. The corrosion-resistant light-emitting diode lamp assembly of clause 43, wherein the first conductive connector crimps to the first uninsulated conductor portion and does not crimp to the first insulated wire portion, and the second conductive connector crimps to the second uninsulated conductor portion and does not crimp to the first insulated wire portion.
Clause 45. The corrosion-resistant light-emitting diode lamp assembly of clause 44, wherein the first and second conductive connectors are entirely within the lamp-socket cavity.
Clause 46. The corrosion-resistant light-emitting diode lamp assembly of clause 41, wherein the first and second conductive connectors are entirely within the lamp-socket cavity.
Clause 47. The corrosion-resistant light-emitting diode lamp assembly of clause 41, further comprising a separator that is positioned between the first wire and the second wire.
Clause 48. The corrosion-resistant light-emitting diode lamp assembly of clause 47, wherein the separator includes a lower portion and an upper portion, the lower portion fitting into a lower opening of the main body of the lamp socket.
Clause 49. The corrosion-resistant light-emitting diode lamp assembly of clause 48, wherein the upper portion of the separator extends through an upper opening of the lamp-socket cavity and outside of the lamp socket.
Clause 50. The corrosion-resistant light-emitting diode lamp assembly of clause 48, wherein the lower portion defines a first channel receiving a portion of the first insulated wire portion and a second channel receiving a portion of the second insulated wire portion, the upper portion extending from the lower portion between the first uninsulated conductor portion and the second uninsulated conductor portion, thereby separating the first wire from the second wire, the first conductive connector from the second connector and the lower portion of the first conductive structure from the lower portion of the second conductive structure.
Clause 51. The corrosion-resistant light-emitting diode lamp assembly of clause 50, wherein, an end of the upper portion is adjacent to the lower surface of the lens.
Clause 52. The corrosion-resistant light-emitting diode lamp assembly of clause 41, wherein the main portion of the lamp socket includes an inside surface defining a first channel receiving a portion of the first insulated wire portion and a second channel receiving a portion of the second insulated wire portion.
Clause 53. The corrosion-resistant light-emitting diode lamp assembly of clause 50, wherein the main portion of the lamp socket includes an inside surface defining a first channel receiving a portion of the first insulated wire portion and a second channel receiving a portion of the second insulated wire portion.
Clause 54. The corrosion-resistant light-emitting diode lamp assembly of clause 50, further comprising a lamp cover having a lower portion inserted into an upper opening of the lamp socket, and an upper portion covering the lens.
Clause 55. A decorative light string comprising a plurality of corrosion-resistant light-emitting diode lamp assemblies according to any one of clauses 41 to 54.
Clause 56. A multi-light-emitting-diode (LED) lamp, comprising: a planar substrate having a first side and a second side; a plurality of conductive portions on the first side of the planar substrate, including a first power-connection portion and a second power-connection portion; a first plurality of LEDs on the first side or the second side of the planar substrate and in electrical connection with the plurality of conductive portions; and a coating covering all of the first plurality of LEDs and configured to pass light emitted from the first plurality of LEDs; wherein the coating covers a majority of the planar substrate without covering the first power-connection point and the second power-connection point.
Clause 57. The multi-LED lamp of clause 56, wherein the planar substrate and the plurality of conductive portions form a printed circuit board.
Clause 58. The multi-LED lamp of clause 56, wherein the first plurality of LEDs are all mounted on the first side of the planar substrate, and the planar substrate comprises a translucent material such that some light emitted from the first plurality of LEDs transmits through the planar substrate.
Clause 59. The multi-LED lamp of clause 56, wherein the coating comprises a phosphor material.
Clause 60. The multi-LED lamp of clause 59, wherein an outer surface of the coating forms a cylindrical shape.
Clause 61. The multi-LED lamp of clause 56, wherein the first power-connection point and the second power-connection point are located at an exposed end of the planar substrate and are in electrical connection with all LEDs of the first plurality of LEDS.
Clause 62. The multi-LED lamp of clause 56, further comprising a second plurality of LEDs, wherein the first plurality of LEDs are electrically connected to one another in series, and the second plurality of LEDs form a rectifying bridge in electrical connection with the first plurality of LEDs.
Clause 63. The multi-LED lamp of clause 62, further comprising a third polarity of LEDs electrically connected to one another in series and a fourth plurality of LEDs electrically connected to form another rectifying bridge, the first plurality of LEDs and the second plurality of LEDs forming a first electrical circuit, the third polarity of LEDs and the fourth polarity of LEDs forming a second electrical circuit, the second electrical circuit electrically connected to the first electrical circuit in parallel.
Clause 63. The multi-LED lamp of clause 56, wherein the first plurality of LEDs comprises a plurality of pairs of LEDs, each pair of LEDs including a first LED and a second LED, wherein the anode of the first LED is electrically connected to the cathode of the second LED and the cathode of the first LED is electrically connected to the anode of the second LED.
Clause 64. A multi-light-emitting-diode (LED) lamp, comprising: a planar substrate;
   a plurality of conductive portions on the planar substrate, including a first power-connection portion and a second power-connection portion; a first plurality of LEDs on the planar substrate and in electrical connection with the plurality of conductive portions; and a transparent or translucent cover covering all of the plurality of LEDs and configured to pass light emitted from the plurality of LEDs; wherein the cover covers a majority of the planar substrate without covering the first power-connection point and the second power-connection point.
Clause 65. The multi-LED lamp of clause 64, wherein the planar substrate and the plurality of conductive portions form a printed circuit board.
Clause 66. The multi-LED lamp of clause 65, wherein the plurality of conductive portions comprise conductive traces on the planar substrate.
Clause 67. The multi-LED lamp of clause 66, wherein the planar substrate comprises a translucent material such that some light emitted from the first plurality of LEDs transmits through the planar substrate.
Clause 68. The multi-LED lamp of clause 64, wherein the cover comprises a transparent polymer material formed onto the planar substrate and the first plurality of LEDs and forming a plurality of parallel grooves on an outer surface of the cover.
Clause 69. The multi-LED lamp of clause 64, further comprising an integrated-circuit controller chip in electrical connection with the first plurality of LEDs.
Clause 69. The multi-LED lamp of clause 64, wherein the cover comprises a coating on the planar substrate, the first plurality of LEDs and the conductive portions.
Clause 70. The multi-LED lamp of clause 64, further comprising a second plurality of LEDs, wherein the first plurality of LEDs are electrically connected to one another in series, and the second plurality of LEDs form a rectifying bridge in electrical connection with the first plurality of LEDs.
Clause 71. The multi-LED lamp of clause 70, further comprising a third polarity of LEDs electrically connected to one another in series and a fourth plurality of LEDs electrically connected to form another rectifying bridge, the first plurality of LEDs and the second plurality of LEDs forming a first electrical circuit, the third polarity of LEDs and the fourth polarity of LEDs forming a second electrical circuit, the second electrical circuit electrically connected to the first electrical circuit in parallel.
Clause 72. The multi-LED lamp of clause 64, wherein the first plurality of LEDs comprises a plurality of pairs of LEDs, each pair of LEDs including a first LED and a second LED, wherein the anode of the first LED is electrically connected to the cathode of the second LED and the cathode of the first LED is electrically connected to the anode of the second LED.
Clause 73. A light-emitting-diode (LED) bulb, comprising: a glass bulb including a main portion and a base portion and defining a bulb cavity; an LED lamp entirely within the bulb cavity, including: a first-polarity lead frame; a second-polarity lead frame; an LED electrically connected to the first-polarity lead frame and the second-polarity lead frame; and a lens covering the LED, an upper portion of the first-polarity lead frame and an upper portion of the second-polarity lead frame; a first extension conductor mechanically and electrically connected to the first-polarity lead frame at a first joint, the first joint within the bulb cavity, and the first extension conductor extending through the base portion of the glass bulb and outside the bulb cavity; a second extension conductor mechanically and electrically connected to the second-polarity lead frame at a second joint, the second joint within the bulb cavity, and the second extension conductor extending through the base portion of the glass bulb and outside of the bulb cavity.
Clause 74. The LED bulb of clause 73, wherein the main portion and the base portion are sealed together and a vacuum is formed in the bulb cavity.
Clause 75. The LED bulb of clause 73, wherein the LED lamp further comprises a bypass element electrically connected to the LED in parallel.
Clause 76. The LED bulb of clause 73, further comprising a resistor electrically connected to the LED in series.
Clause 77. The LED bulb of clause 73, wherein the lens comprises an epoxy material. Clause 78. The LED bulb of clause 77, wherein the lens forms a cylindrical shape.
Clause 79. The LED bulb of clause 73, wherein the first extension conductor and the second extension conductor each are Dumet wires.
Clause 80. The LED bulb of clause 74, wherein the first and second joints comprise solder joints.
Clause 81. The LED bulb of clause 74, wherein the LED lamp further includes another LED.
Clause 82. The LED bulb of clause 81, wherein the other LED is electrically connected to the LED in parallel.
Clause 83. A corrosion-resistant light-emitting diode (LED) lamp assembly, comprising: a lamp socket defining a lamp-receiving cavity with a first opening and a second opening and including an inner surface; an LED lamp comprising at least one LED and a lens, the lens projecting through the first opening such that a portion of the lens is inside the lamp-receiving cavity and another portion of the lens is outside of the lamp-receiving cavity, wherein the lens and the lamp socket form a filling gap therebetween, a first wire including a first conductive portion and a first insulated portion, the first conductive portion electrically connected to the LED lamp; a second wire including a second conductive portion and a second insulated portion, the second conductive portion electrically connected to the LED lamp; a separator portion in the second opening of the lamp socket and positioned between the first insulated portion and the second insulator portion; and sealing material filling a portion of the lamp-receiving cavity and contacting the first conductive portion of the first wire, the second conductive portion of the second wire, the inner surface of the lamp socket, and the outer side surface of the lens.
Clause 84. The corrosion-resistant LED lamp assembly of clause 83, wherein the LED includes: a first-polarity lead frame in electrical connection with an anode of the LED; a second-polarity lead frame in electrical connection with the cathode of the LED; and wherein the lens covers the LED, an upper portion of the first-polarity lead frame and an upper portion of the second-polarity lead frame, the lens including an outer side surface.
Clause 85. The corrosion-resistant LED lamp assembly of clause 84, further comprising a first electrical connector mechanically and electrically connecting the first-polarity lead frame to the first conductive portion of the first wire and a second electrical connector mechanically and electrically connecting the second-polarity lead frame to the second conductive portion of the second wire, and wherein the sealing material contacts the first electrical connector, the second electrical connector, the first-polarity lead frame and the second polarity lead frame.
Clause 86. The corrosion-resistant LED lamp assembly of clause 85, wherein the sealing material only partially covers the portion of the lens inside the lamp-receiving cavity, leaving a space between the inner surface of the lamp socket and the lens inside the lamp-receiving cavity. Clause 87. The corrosion-resistant LED lamp assembly of clause 86, further comprising a lamp cover, wherein a lower portion of the lamp cover is received into the space between the inner surface of the lamp socket and the lens inside the lamp-receiving cavity.
Clause 88. The corrosion-resistant LED lamp assembly of clause 83, wherein the LED lamp is a multi-LED lamp including a plurality of LEDs.
Clause 89. The corrosion-resistant LED lamp assembly of clause 88, wherein the multi-LED lamp includes a printed circuit board, and the plurality of LEDs are mounted to the printed circuit board.
Clause 90. The corrosion-resistant LED lamp assembly of clause 83, wherein the separator portion includes a lower portion and an upper portion, the lower portion positioned in the second opening of the lamp socket and positioned between the first insulated portion and the second insulator portion, and the upper portion positioned between the first conductive portion of the first wire and the second conductive portion of the second wire.
Clause 91. The corrosion-resistant LED lamp assembly of clause 90, wherein a cavity gap is formed between an end of the upper portion of the separator and a lower surface of the LED lens, and the sealing material fills the cavity gap such that the sealing material is in contact with the end of the upper portion of the separator and the lower surface of the LED lens.
Clause 92. The corrosion-resistant LED lamp assembly of clause 83, wherein the sealing material is an epoxy material configured to be cured by exposure to ultraviolet light.
Clause 93. The corrosion-resistant LED lamp assembly of clause 83, wherein the sealing material comprises one or more of an epoxy, resin, silicone and AB glue.
Clause 94. A light string comprising a plurality of LED lamp assemblies according to clause 83.
Clause 95. The light string of clause 94, further comprising a power plug configured to connect to an alternating-current (AC) power source, a power converter configured to reduce an AC voltage from the power source to a lower AC voltage, and wherein the plurality of lamp assemblies are in electrical connection with the power converter to receive reduced voltage AC power.
Clause 96. The light string of clause 95, wherein each of the plurality of LED lamp assemblies is electrically connected to one another in series.
Clause 97. The light string of clause 95, wherein each of the plurality of LED lamp assemblies is electrically connected to one another in parallel.
Clause 98. A corrosion-resistant light-emitting diode (LED) lamp assembly, comprising: a lamp socket defining a lamp-receiving cavity with a first opening and a second opening and including an inner surface; an LED lamp projecting through the first opening, the LED including: a first-polarity lead frame; a second-polarity lead frame; an LED electrically connected to the first-polarity lead frame and the second-polarity lead frame; and a lens covering the LED, an upper portion of the first-polarity lead frame and an upper portion of the second-polarity lead frame, the lens including an outer side surface; a first wire including a first conductive portion and a first insulated portion, the first conductive portion electrically connected to the first-polarity lead frame; a second wire including a second conductive portion and a second insulated portion, the second conductive portion electrically connected to the second-polarity lead frame; a separator portion including a lower portion and an upper portion, the lower portion positioned in the second opening of the lamp socket and positioned between the first insulated portion and the second insulator portion, and the upper portion positioned between the first conductive portion of the first wire and the second conductive portion of the second wire; sealing material filling a majority of the lamp-receiving cavity and contacting the first-polarity lead frame, the second-polarity lead frame, the first conductive portion and the second conductive portion, the inner surface of the lamp socket, and the outer side surface of the LED lens.
Clause 99. A light-emitting diode (LED) bulb assembly, comprising: a lamp socket defining a lamp-receiving cavity with a first opening and a second opening and including an inner surface; an LED lamp the LED lamp including: a first-polarity lead frame; a second-polarity lead frame; an LED electrically connected to the first-polarity lead frame and the second-polarity lead frame; and a lens covering the LED, an upper portion of the first-polarity lead frame and an upper portion of the second-polarity lead frame, the lens including an outer side surface, the outer side surface of the lens and the lamp socket forming a filling gap; a first wire including a first conductive portion and a first insulated portion, the first conductive portion electrically connected to the first-polarity lead frame; a second wire including a second conductive portion and a second insulated portion, the second conductive portion electrically connected to the second-polarity lead frame; a separator portion having a lower portion and an upper portion, the lower portion positioned in the second opening of the lamp socket between the first insulated portion of the first wire and the second insulator portion of the second wire, and the upper portion positioned between the first conductive portion and the second conductive portion; ultraviolet-curable sealing material filling a portion of the lamp-receiving cavity and contacting the first-polarity lead frame, the second-polarity lead frame, the first conductive portion and the second conductive portion, and the outer side surface of the LED lens; and a lamp cover having a base portion inserted into an upper portion of the lamp-receiving cavity devoid of the ultraviolet-curable sealing material.
Clause 100. A corrosion-resistant light-emitting diode (LED) bulb assembly, comprising: a lamp socket including an inner body portion and an outer body, the inner body portion defining a lamp-receiving cavity with a first opening and a second opening, the outer body portion defining a cover-base-receiving cavity, and wherein the lamp-receiving cavity and the cover-base-receiving cavity are separated by the inner body portion, such that the lamp-receiving cavity and the cover-base receiving cavity are not in fluid communication with one another; an LED lamp at least partially within the lamp-receiving cavity of the inner body portion, including: a first-polarity conductor; a second-polarity conductor; a first LED electrically connected to the first-polarity conductor and the second-polarity conductor; and a lens covering the LED, an upper portion of the first-polarity lead frame and an upper portion of the second-polarity lead frame, the lens including an outer side surface; a first wire including a first conductive portion and a first insulated portion, the first conductive portion electrically connected to the first-polarity lead frame; a second wire including a second conductive portion and a second insulated portion, the second conductive portion electrically connected to the second-polarity lead frame; a separator portion positioned in the second opening of the lamp socket between the first insulated portion of the first wire and the second insulator portion of the second wire; a lamp cover including a base portion received into the cover-base-receiving cavity defined by the outer body portion; and sealing material filling a portion of the lamp-receiving cavity and contacting the first-polarity lead frame, the second-polarity lead frame, the first conductive portion and the second conductive portion, and the outer side surface of the LED lens.
Clause 101. The corrosion-resistant LED bulb assembly of clause 100, wherein the outer side surface of the lens and the lamp socket form a filling gap configured to pass the sealing material.
Clause 102. The corrosion-resistant LED bulb assembly of clause 100, wherein the separator portion includes a lower portion and an upper portion with an upper end, the lower portion positioned in the second opening of the lamp socket between the first insulated portion of the first wire and the second insulator portion of the second wire, and the upper portion positioned between the first conductive portion and the second conductive portion.
Clause 103. The corrosion-resistant LED bulb assembly of clause 102, wherein the upper end of the upper portion of the separator portion and a bottom surface of the lens define a cavity gap.
Clause 104. The corrosion-resistant light-emitting diode (LED) bulb assembly of clause 103, wherein the sealing material fills the cavity gap.
Clause 105. The corrosion-resistant LED bulb assembly of clause 100, wherein the LED lamp comprises a first plurality of LEDs, and the first LED is one of the plurality of LEDs.
Clause 106. The corrosion-resistant LED bulb assembly of clause 105, wherein the first plurality of LEDs are electrically connected to one another in parallel.
Clause 107. The corrosion-resistant LED bulb assembly of clause 105, wherein the first plurality of LEDs are electrically connected to one another in series.
Clause 108. The corrosion-resistant LED bulb assembly of clause 106, further comprising a second plurality of LEDs.
Clause 109. The corrosion-resistant LED bulb assembly of clause 108, wherein the second plurality of LEDs comprises a rectifying bridge in electrical connection with the first plurality of LEDs.
Clause 110. The corrosion-resistant LED bulb assembly of clause 108, wherein the second plurality of LEDs comprises multiple LEDs electrically connected to one another in series, and wherein the first plurality of LEDs is electrically connected to the second plurality of LEDs in parallel.
Clause 111. The corrosion-resistant LED bulb assembly of clause 100, wherein the cover includes an upper portion formed as a globe shape integrally formed with the cover base.
Clause 112. The corrosion-resistant LED bulb assembly of clause 100, wherein the cover base receives a circumferential ridge projecting from a bottom surface of a bottom portion of the outer body portion.
Clause 113. A light string comprising a plurality of LED lamp assemblies according to clause 47.
Clause 114. The light string of clause 113, further comprising a power plug configured to connect to an alternating-current (AC) power source, a power converter configured to reduce an AC voltage from the power source to a lower AC voltage, and wherein the plurality of lamp assemblies are in electrical connection with the power converter to receive reduced voltage AC power.
Clause 115. The light string of clause 114, wherein each of the plurality of LED lamp assemblies is electrically connected to one another in series.
Clause 116. The light string of clause 114, wherein each of the plurality of LED lamp assemblies is electrically connected to one another in parallel.

The embodiments above are intended to be illustrative and not limiting. Additional embodiments are within the clauses. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A corrosion-resistant light-emitting diode (LED) lamp assembly, comprising:
a lamp socket defining a lamp-receiving cavity with a first opening and a second opening and including an inner surface;
an LED lamp comprising at least one LED and a lens, the lens projecting through the first opening such that a portion of the lens is inside the lamp-receiving cavity and another portion of the lens is outside of the lamp-receiving cavity, wherein the lens and the lamp socket form a filling gap therebetween;
a first wire including a first conductive portion and a first insulated portion, the first conductive portion electrically connected to the LED lamp;
a second wire including a second conductive portion and a second insulated portion, the second conductive portion electrically connected to the LED lamp;
a separator portion in the second opening of the lamp socket and positioned between the first insulated portion and the second insulator portion; and
sealing material filling a portion of the lamp-receiving cavity and contacting the first conductive portion of the first wire, the second conductive portion of the second wire, the inner surface of the lamp socket, and the outer side surface of the lens.

2. The corrosion-resistant LED lamp assembly of claim 1, wherein the LED includes:
a first-polarity lead frame in electrical connection with an anode of the LED;
a second-polarity lead frame in electrical connection with the cathode of the LED; and
wherein the lens covers the LED, an upper portion of the first-polarity lead frame and an upper portion of the second-polarity lead frame, the lens including an outer side surface.

3. The corrosion-resistant LED lamp assembly of claim 2, further comprising a first electrical connector mechanically and electrically connecting the first-polarity lead frame to the first conductive portion of the first wire and a second electrical connector mechanically and electrically connecting the second-polarity lead frame to the second conductive portion of the second wire, and wherein the sealing material contacts the first electrical connector, the second electrical connector, the first-polarity lead frame and the second polarity lead frame.

4. The corrosion-resistant LED lamp assembly of claim 3, wherein the sealing material only partially covers the portion of the lens inside the lamp-receiving cavity, leaving a space between the inner surface of the lamp socket and the lens inside the lamp-receiving cavity.

5. The corrosion-resistant LED lamp assembly of claim 4, further comprising a lamp cover, wherein a lower portion of the lamp cover is received into the space between the inner surface of the lamp socket and the lens inside the lamp-receiving cavity.

6. The corrosion-resistant LED lamp assembly of claim 1, wherein the LED lamp is a multi-LED lamp including a plurality of LEDs.

7. The corrosion-resistant LED lamp assembly of claim 6, wherein the multi-LED lamp includes a printed circuit board, and the plurality of LEDs are mounted to the printed circuit board.

8. The corrosion-resistant LED lamp assembly of claim 1, wherein the separator portion includes a lower portion and an upper portion, the lower portion positioned in the second opening of the lamp socket and positioned between the first insulated portion and the second insulator portion, and the upper portion positioned between the first conductive portion of the first wire and the second conductive portion of the second wire.

9. The corrosion-resistant LED lamp assembly of claim 8, wherein a cavity gap is formed between an end of the upper portion of the separator and a lower surface of the LED lens, and the sealing material fills the cavity gap such that the sealing material is in contact with the end of the upper portion of the separator and the lower surface of the LED lens.

10. The corrosion-resistant LED lamp assembly of claim 1, wherein the sealing material is an epoxy material configured to be cured by exposure to ultraviolet light.

11. The corrosion-resistant LED lamp assembly of claim 1, wherein the sealing material comprises one or more of an epoxy, resin, silicone and AB glue.

12. A light string comprising a plurality of LED lamp assemblies according to claim 1.

13. The light string of claim 12, further comprising a power plug configured to connect to an alternating-current (AC) power source, a power converter configured to reduce an AC voltage from the power source to a lower AC voltage, and wherein the plurality of lamp assemblies are in electrical connection with the power converter to receive reduced voltage AC power.

14. The light string of claim 13, wherein each of the plurality of LED lamp assemblies is electrically connected to one another in series.

15. The light string of claim 13, wherein each of the plurality of LED lamp assemblies is electrically connected to one another in parallel.

16. A corrosion-resistant light-emitting diode (LED) lamp assembly, comprising:
a lamp socket defining a lamp-receiving cavity with a first opening and a second opening and including an inner surface;
an LED lamp projecting through the first opening, the LED including:
a first-polarity lead frame;
a second-polarity lead frame;
an LED electrically connected to the first-polarity lead frame and the second-polarity lead frame; and
a lens covering the LED, an upper portion of the first-polarity lead frame and an upper portion of the second-polarity lead frame, the lens including an outer side surface;
a first wire including a first conductive portion and a first insulated portion, the first conductive portion electrically connected to the first-polarity lead frame;
a second wire including a second conductive portion and a second insulated portion, the second conductive portion electrically connected to the second-polarity lead frame;
a separator portion including a lower portion and an upper portion, the lower portion positioned in the second opening of the lamp socket and positioned between the first insulated portion and the second insulator portion, and the upper portion positioned between the first conductive portion of the first wire and the second conductive portion of the second wire; and
sealing material filling a majority of the lamp-receiving cavity and contacting the first-polarity lead frame, the second-polarity lead frame, the first conductive portion and the second conductive portion, the inner surface of the lamp socket, and the outer side surface of the LED lens.

17. A light-emitting diode (LED) bulb assembly, comprising:
a lamp socket defining a lamp-receiving cavity with a first opening and a second opening and including an inner surface;
an LED lamp the LED lamp including:
a first-polarity lead frame;
a second-polarity lead frame;
an LED electrically connected to the first-polarity lead frame and the second-polarity lead frame; and
a lens covering the LED, an upper portion of the first-polarity lead frame and an upper portion of the second-polarity lead frame, the lens including an outer side surface, the outer side surface of the lens and the lamp socket forming a filling gap;
a first wire including a first conductive portion and a first insulated portion, the first conductive portion electrically connected to the first-polarity lead frame;
a second wire including a second conductive portion and a second insulated portion, the second conductive portion electrically connected to the second-polarity lead frame;
a separator portion having a lower portion and an upper portion, the lower portion positioned in the second opening of the lamp socket between the first insulated portion of the first wire and the second insulator portion of the second wire, and the upper portion positioned between the first conductive portion and the second conductive portion;
ultraviolet-curable sealing material filling a portion of the lamp-receiving cavity and contacting the first-polarity lead frame, the second-polarity lead frame, the first conductive portion and the second conductive portion, and the outer side surface of the LED lens; and
a lamp cover having a base portion inserted into an upper portion of the lamp-receiving cavity devoid of the ultraviolet-curable sealing material.

18. A light string comprising a plurality of LED lamp assemblies according to claim 17.

19. The light string of claim 18, wherein each of the plurality of LED lamp assemblies is electrically connected to one another in series.

20. The light string of claim 18, wherein each of the plurality of LED lamp assemblies is electrically connected to one another in parallel.
